(19) United States
(12) Patent Application Publication
(10) Pub. No.: US 2012/0158464 A1
(43) Pub. Date: Jun. 21, 2012

(54) VISUALIZATION SYSTEM FOR ORGANIZATIONAL COMMUNICATION

(76) Inventors: Satomi TSUJI, Kokubunji (JP); Kazuo Yano, Hino (JP); Nobuo Sato, Saitama (JP)

(21) Appl. No.: 13/405,913

(22) Filed: Feb. 27, 2012

Related U.S. Application Data
(62) Division of application No. 12/129,309, filed on May 29, 2008.

(30) Foreign Application Priority Data
Jun. 28, 2007 (JP) 2007-169874

(51) Int. Cl. G06Q 10/06

(52) U.S. Cl. 705/7.38

(57) ABSTRACT

To provide a visualization method for analyzing the condition of an organization, the condition of a sub-organization, and the condition of an individual, with the face-to-face contact communication between members belonging to an organization being used as a cross section. A sensor-net system comprises a plurality of terminals and a processing unit that processes data sent from the plurality of terminals, wherein the each terminal comprises: a sensor for detecting a physical quantity; and a data sender unit that sends data indicative of the physical quantity detected by the sensor, and wherein based on the data sent from a first terminal, the processing unit plots this data on a coordinate plane consisting of two axes, in which an intensity of a relation, which a first person equipped with the first terminal has with other person, is assigned to one axis and a diversity of the relation is assigned to the other axis.

### INCORPORATION BY REFERENCE

The present application claims priority from Japanese application JP2007-169874 filed on Jun. 28, 2007 and is a divisional application of U.S. application Ser. No. 12/129,309, filed May 29, 2008, the contents of which are hereby incorporated by reference into this application.

### BACKGROUND OF THE INVENTION

The present invention relates to visualization systems for organizational communication, which visualize an individual's communication style in an organization and furthermore an organizational communication style based on interaction data between persons equipped with a sensor terminal.

Conventionally, there has been disclosed a technique that visualizes a human relation as a network by analyzing communications through mobile phones from the send and receive history (for example, see Eagle, N., and Pentland, A., “Reality Mining: Sensing Complex Social Systems”, J. of Personal and Ubiquitous Computing, July 2005).

Moreover, conventionally, there has been disclosed a technique that utilizes the records of communications performed through a plurality of means, such as the logs of e-mails and the minutes of meetings in an organization or between organizations, to integrate these into a common index for displaying (for example, see JP-A-2006-127142).

An improvement in productivity is an essential issue in every organization, and thus a lot of trials and errors have been performed to achieve an improvement in the work environment and an operational efficiency. When limited to an organization having a function of assembling components or transporting products in a factory or the like, the process or result thereof can be objectively analyzed by tracking the move path of the components or products. On the other hand, for an organization consisting of knowledge workers, a system that visualizes a work process by utilizing the use log of an electronic document or an IT apparatus (instead of utilizing an article) is already known.

In the first place, an organization is formed in order to accomplish an extensive work, which an individual cannot accomplish, by a plurality of people working together as a team. Accordingly, in any organization, for the purpose of making decision and reaching an agreement among a plurality of people, communication is always performed. While the means for performing communication include a telephone, a facsimile, an e-mail, or the like, the most frequently performed and most influential one is a face-to-face communication. The face-to-face communication can take maximum advantage of the body of human being, such as a gesture, direction of eyes, a facial expression, and a tone of voice. For this reason, most of communications essential in an organization, such as the formation of a friendly relation through daily greetings and the compromise at a negotiating table intricately intertwined with an interest, are naturally achieved by the face-to-face communication.

Moreover, in the face-to-face communication, two or more persons concerned will produce rhythms in the conversation or an atmosphere in the scene, in real time. For this reason, sympathy in feelings or emergence of an idea sometimes may unexpectedly occur. In the achievement of a knowledge work-oriented organization, a creative idea produced in this way contributes a lot. The number of organizations that perceive importance of this aspect and introduce a trial, such as a free address seat system or the formation of a cross functional project, tends to increase in recent years. Either of the above-described trials expects the emergence of a new value by preparing an opportunity for people having various kinds of backgrounds to contact to each other.

Any one of the conventional methods analyzes primarily on a task itself, however, with regard to a knowledge work, the essence thereof cannot be grasped unless the analysis is conducted primarily on people itself. This is because the maximum results cannot be achieved just by cutting out the procedure or time for each task and aiming at achieving efficiency. Accordingly, in order to achieve an excellent result in the knowledge work, it may be necessary to focus on an individual's characteristic feature, in particular to know his/her working style. The working style here refers to an individual's pattern of how to proceed with the work, i.e., when, where, and what to be done. The working style is reflected by both the content of a work (i.e., an external factor) and the character of a relevant person (i.e., an internal factor). A professional in a knowledge work has already established his/her own working style. Some people get an idea through discussion, while others take plenty of time to think left alone. Moreover, some people walk around outside, others sit down in front of a desk to turn pages of a magazine, and there is thus a great diversity in their working styles. By the amount that the knowledge work is especially mental, methods for achieving the maximum effectiveness will differ depending on the individual's qualification, assumed role, and the like. However, the conventional task-oriented analysis method does not take into consideration at all an influence caused by matters, for example, such as reading, walking, and chatting, which are not directly reflected on the deliverables of the work. Accordingly, it is necessary to capture the working style by focusing on people itself and by observing the actual behavior of an individual member. Then, by mutually recognizing and respecting the individual's working style, the working style as a whole organization may be established, leading to an improvement in productivity.

Furthermore, most of creativities in a knowledge work may be produced through daily communications with others. From this fact, among the working styles, how to conduct communication is the key. Thus, this is referred to as a “communication style”, and it is necessary to find out a cross section for analyzing the communication style. The communication style is a pattern of an individual's way how to conduct communication in a work, such as utilizing a chat with a friend as energy for the work, putting an emphasis on a thorough discussion, or preferring to take plenty of time to think through without being interrupted by anybody. As in the working style, the communication style also should be captured by focusing on people itself and by observing his/her actual communication. Moreover, based on a total sum or a distribution of the communication styles of all or some of the members belonging to an organization, the vitality of the whole organization or a deviation in the members is captured and this captured one is regarded as the communication style of the organization. Moreover, for each of a plurality of sub-organizations existing in an organization, vitality thereof or a deviation in communication styles of the members belonging to each sub-group is captured and this captured one is regarded as the communication style of the sub-organization.

However, neither of the above-described Eagle, N., and Pentland, A., “Reality Mining: Sensing Complex Social Systems”, J. of Personal and Ubiquitous Computing, July 2005 nor JP-A-2006-127142 discloses any specific visualization system for capturing the communication style of an individual belonging to an organization, the communication style of an organization, or the communication style of a sub-organization included in the organization by observing actual face-to-face communication.

### SUMMARY OF THE INVENTION

It is an object of the present invention to provide a visualization system for capturing the communication style of an individual belonging to an organization, the communication style of an organization, or the communication style of a sub-organization included in the organization by observing actual face-to-face communication.

An example of the representative ones of the present invention is as follows. That is, a visualization system for organizational communication of the present invention comprises a plurality of terminals and a processing unit that processes data sent from the plurality of terminals, wherein the each terminal comprises a sensor that detects a face-to-face contact state with respect to other terminal, and a data sender unit that sends data detected by the sensor, and wherein based on the data sent from a first terminal, the processing unit combines and displays two types of feature quantities, i.e., a feature quantity indicative of an intensity of a relation which a first person or article equipped with the first terminal has with other person or article in a relevant organization, and a feature quantity indicative of a diversity in the relation which the first person or article equipped with the first terminal has with other person or article in the relevant organization.

According to the present invention, the communication style of a member belonging to an organization, the communication style of an organization, and the communication style of a sub-organization can be visualized from actual face-to-face communication data.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are an explanatory view of the configuration of a whole system including from a terminal for acquiring interaction data to a display for a created image, in a first embodiment of the present invention.

FIG. 2 is a sequence diagram showing the processes until a sensor data is provided from the terminal to a user, in the first embodiment of the present invention.

FIG. 3 is a flowchart showing processes that are performed to create a display screen, in the first embodiment of the present invention.

FIG. 4 is a flowchart showing processes that are performed to set an initial condition, in the first embodiment of the present invention.

FIG. 5 is an explanatory view showing an example of a user ID reference table, according to the first embodiment of the present invention.

FIG. 6 is an explanatory view showing an example of a project member reference table, according to the first embodiment of the present invention.

FIG. 7 is an explanatory view showing an example of a screen that is displayed for initial condition setting, according to the first embodiment of the present invention.

FIG. 8 is a flowchart showing a step of getting data to a step of calculating a contact matrix, performed in the first embodiment of the present invention.

FIG. 9A is an explanatory view of a database unit which a sensor net server of the first embodiment of the present invention retains.

FIG. 9B is an explanatory view of the database unit which the sensor net server of the first embodiment of the present invention retains.

FIG. 10 is an explanatory view of a connected table created by an application server of the first embodiment of the present invention.

FIG. 11 is an explanatory view of a contact matrix created by the application server of the first embodiment of the present invention.

FIG. 12 is a flowchart showing processes that are executed to calculate a contacting number and a contacting time, in the first embodiment of the present invention.

FIG. 13 is a flowchart showing processes that are executed to plot data, in the first embodiment of the present invention.

FIG. 14 is an example of a graph outputted as a result of executing the first embodiment of the present invention.

FIGS. 15A to 15E show an example of the project-based graph outputted as a result of executing the first embodiment of the present invention.

FIGS. 16A to 16F show an example of the graph of a chronological change in an organization, outputted as a result of executing the first embodiment of the present invention.

FIGS. 17A to 17D show an example of the graph of a chronological change in a project, outputted as a result of executing the first embodiment of the present invention.

FIG. 18 is an explanatory view of four areas, in a second embodiment of the present invention.

FIG. 19 is a flowchart showing processes that are performed to plot data, in the second embodiment of the present invention.

FIG. 20 is an example of the graph outputted as a result of executing the second embodiment of the present invention.

FIGS. 21A to 21E show an example of the project-based graph outputted as a result of executing the second embodiment of the present invention.

FIG. 22 is an explanatory view of an expression method in a third embodiment of the present invention.

FIG. 23 is a flowchart showing processes that are executed to plot data, in the third embodiment of the present invention.

FIG. 24 is an example of the graph of the project-based chronological change, outputted as a result of executing the third embodiment of the present invention.

FIG. 25 is an example of the graph outputted as a result of executing a fourth embodiment of the present invention.

FIG. 26 is an explanatory view of an expression method in the fourth embodiment of the present invention.

FIGS. 27A and 27B are an explanatory view of the configuration of a whole system including from a terminal for acquiring interaction data to a display for a created image, in the fourth embodiment of the present invention.

FIGS. 28A and 28B are a sequence diagram showing the processes until sensor data is provided from the terminal to a user, in the fourth embodiment of the present invention.

FIG. 29 is a flowchart showing processes that are executed to plot data, in the fourth embodiment of the present invention.

FIG. 30 is a sample of a self-rating questionnaire used in the fourth embodiment of the present invention.

FIG. 31 is an explanatory view showing an example of a performance connected table of the fourth embodiment of the present invention.

FIG. 32 is an example of the graph outputted as a result of executing a fifth embodiment of the present invention.

FIG. 33 is an example of the graph outputted as a result of executing the fifth embodiment of the present invention.

FIG. 34 is an explanatory view of a projection onto a principal component axis, in the fifth embodiment of the present invention.

FIG. 35 is a flowchart showing processes that are executed to plot data, in the fifth embodiment of the present invention.

FIG. 36 is an example of the graph outputted as a result of executing a sixth embodiment of the present invention.

FIG. 37 is an explanatory view of associating feature quantities with colors used in the sixth embodiment of the present invention.

### DETAILED DESCRIPTION OF THE EMBODIMENTS

A display system for expressing the situation of an individual and organization has been achieved by acquiring data concerning a face-to-face contact between a target person and other person from a sensor terminal attached to the target person and by plotting the acquired data with a diversity and an amount of communication taken on two axes.

### Embodiment 1

First, a first embodiment of the present invention is described with reference to the accompanying drawings.

### <Overview of Whole Process Flow>

In the first embodiment, each member of an organization is equipped with a sensor terminal (TR) including a wireless transceiver, and with this terminal (TR) the data concerning interaction between the respective members is acquired. The acquired data is sent to a gateway (GW) by air and is furthermore stored in a sensor net server (SS). In creating a display concerning an organizational communication, a request is issued from a client (CL) to an application server (AS), and the data concerning a member belonging to an organization is retrieved from the sensor net server (SS). Then, in the application server (AS), this data is processed and plotted based on an amount and diversity of communication of each member to create an image. Furthermore, this image is returned to the client (CL) and displayed. A visualization system for organizational communication including these series of processes has been achieved.

Specifically, the visualization system for organizational communication comprises a plurality of terminals and a processing unit that processes data sent from the plurality of terminals, wherein each terminal comprises: a sensor that detects a face-to-face contact with other terminal; and a data sender unit that sends the data detected by the sensor, and wherein based on the data sent from a first terminal the processing unit performs a correlated display by visually correlating a feature quantity indicative of an intensity of a relation, which a first person equipped with the first terminal has with other person in the relevant organization, with a feature quantity indicative of a diversity in the relation, and thereby visualizes a communication style of the relevant organization.

### <Description of Display Contents and its Effect>

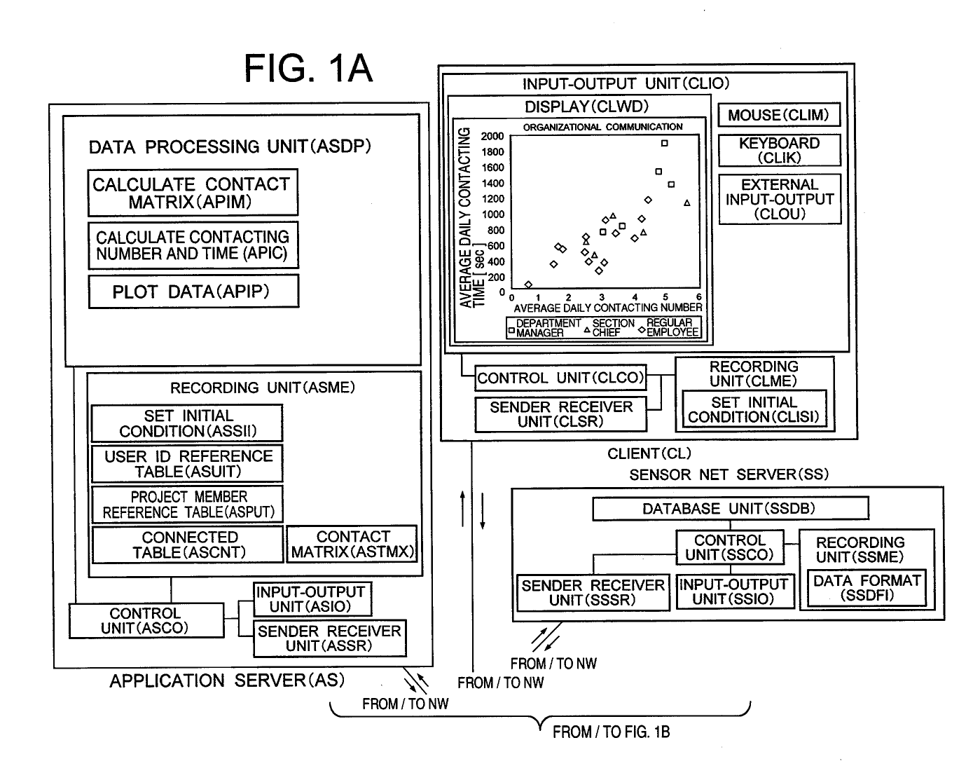

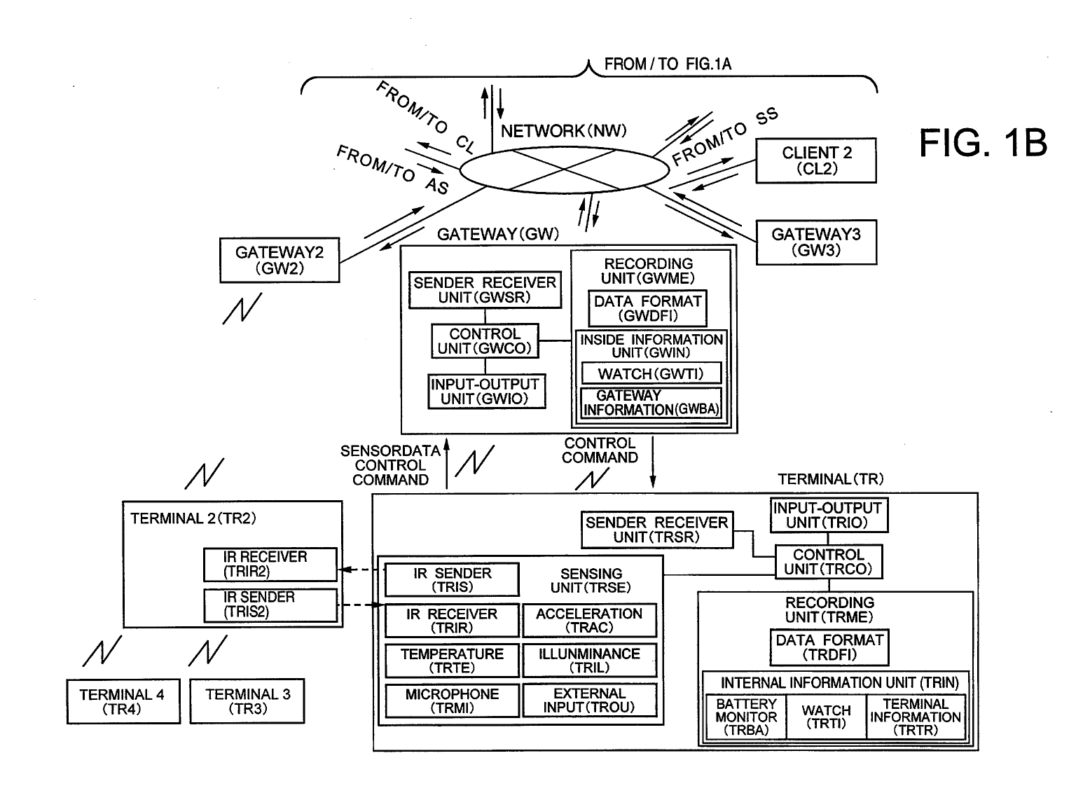

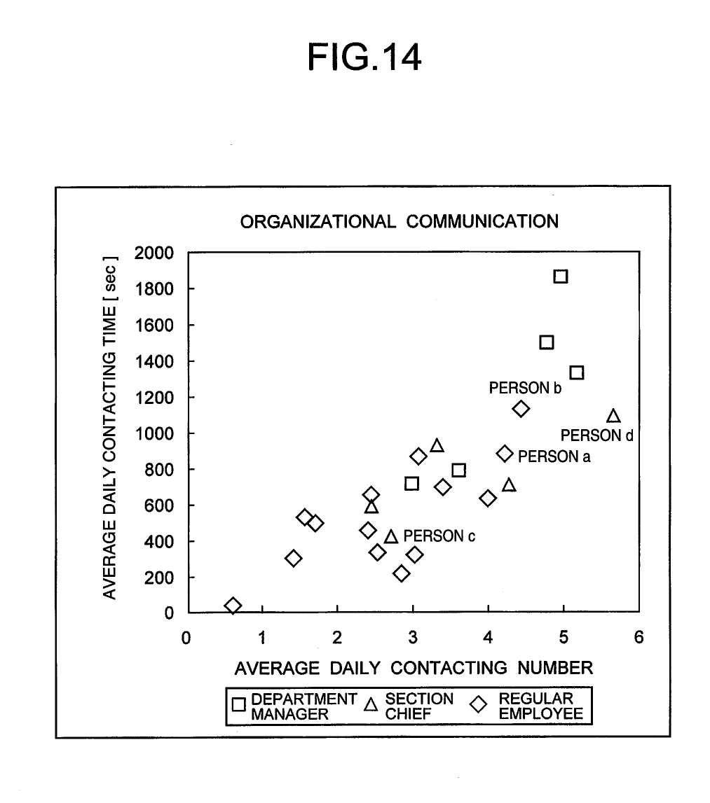

The first embodiment is the one for drawing a graph indicative of an organizational communication as shown inside a display (CLWD) of FIG. 1 or as shown as an example in FIG. 14. This graph is obtained by plotting data, e.g., in the unit of day, with the number of other persons whom each member contacted in a day being taken on the horizontal axis and a sum of contacting time with somebody being taken on the vertical axis. Here, a sum of the contacting time can be considered as the amount of communication of each member. Moreover, in a knowledge work organization, a new idea or value may be more likely to emerge through communication with other person having various kinds of knowledges and backgrounds. Accordingly, the contacting number on the horizontal axis can be considered, from a point of view, as an indication of a diversity in communication which each member is performing. With these two as the axes, the positions of all or some of the members belonging to an organization are plotted. This makes it possible to know how communications, as a whole organization, are distributed and performed. For example, whether or not the communication concentrates on only some of the members, whether or not all the members are actively involved in communication, or the like can be known. Furthermore, if the display is chronologically segmented and expressed, then by checking the activeness or deviation of the whole organization with the work content in each period, it is possible to use the display also as a material for determining whether or not the phase of a work matches with the way how the communication is performed. Moreover, for the sub-organization such as a project in an organization, the form of an organizational administration by a leader in accordance with the membership and the work contents can be visualized by the way how the communication is performed. Focusing on an individual, it is possible to know who or what type of member is actively communicating and what type of member puts priority on an individual's task rather than on communication. Moreover, while a member who takes communication with a lot of other people also outside his/her own work may create an opportunity for the emergence of knowledge, it is possible to know who such member is. The horizontal axis and the vertical axis may be interchanged to plot with the contacting number as the vertical axis and the contacting time as the horizontal axis.

In this case, the above-described correlated display is a display performed by plotting a symbol corresponding to a person onto a coordinate plane consisting of two axes, in which a feature quantity indicative of an intensity is assigned to one axis and a feature quantity indicative of a diversity is assigned to the other axis.

The abobe-described effects are the ones actually verified with the experimental data obtained in an organization that has been proactively performing a trial, such as the formation of a cross-functional project, for activating the knowledge work. The detail of the result will be described later.

### <Whole System>

FIG. 1 is an explanatory view of the configuration of a whole system including from a terminal for acquiring interaction data to an application for displaying the acquired data, in the first embodiment of the present invention.

A user (US) receives the display concerning an organizational communication by operating the client (CL). The client (CL) connects to the application server (AS) via a network (NW), and receives data-processing result information (an organizational communication display) created by the application server, and outputs this on the display (CLWD) or the like.

The application server (AS) connects to a sensor net server (SS) via the network (NW) and receives sensor data stored in a database unit (SSDB). The application server (AS) creates an image by processing and plotting the received information.

The sensor net server (SS) connects to the gateway (GW) via the network (NW) and receives the sensor data. The gateway (GW) sends the sensor data to the sensor net server (SS) via the network (NW).

The gateway (GW) receives the sensor data from a terminal (TR) via a sender-receiver unit (GWSR).

The terminal (TR) is attached to a person and acquires sensor data by a sensing unit (TRSE). Within an area where the gateway (GW) can communicate, there are a terminal 2 (TR2) to a terminal 4 (TR4). Each of the terminal 2 (TR2) to the terminal 4 (TR4) is attached to each person and acquires sensor data by a sensing unit (not illustrated), as in the terminal (TR). The terminal (TR) and the terminal 2 (TR2) to terminal 4 (TR4) send the acquired sensor data to the gateway (GW) using the sender-receiver unit (TRSR). The sensor data sent by the terminal (TR) and the terminal 2 (TR2) to terminal 4 (TR4) includes information for identifying the terminal (TR) and the terminal 2 (TR2) to terminal 4 (TR4) that acquired the relevant data.

### <Terminal>

The terminal (TR) is a portable terminal and is attached to a person to be sensed. Hereinafter, the configuration of the terminal (TR) is described. FIG. 1 further illustrates three terminals from the terminal 2 (TR2) to the terminal 4 (TR4). Since the description of these terminals are the same as that of the terminal (TR), the description thereof is omitted below. Accordingly, the following description is established even if the terminal (TR) is replaced with either one of the terminal 2 (TR2) to the terminal 4 (TR4). Note that the present invention is applicable even when there are any number of similar terminals.

An IR sender (TRIS) and an IR receiver (TRIR) are mounted on the terminal (TR). With the use of these, IR is exchanged between the terminals (TR), thereby detecting whether or not the relevant terminal (TR) contacted to other terminal (TR). For this reason, the terminal (TR) is preferably attached to a person's front part. For example, the terminal (TR) may be of a name tag type and be hung from a person's neck with a string. In the case where the terminal (TR) is attached to a person's front part, the fact that the terminal (TR) faced other terminal (TR) means that persons equipped with these terminals (TR) contacted to each other.

Note that, hereinafter, an example is described, in which whether or not the terminal (TR) faced other terminal (TR) is determined based on the fact that the terminal (TR) exchanges an IR signal. However, actually, the contact status may be determined by exchanging a radio signal other than the IR signal.

Moreover, the terminal (TR) comprises the sender-receiver unit (TRSR), the sensing unit (TRSE), an input-output unit (TRIO), a control unit (TRCO), and a recording unit (TRME), and sends the data sensed by the sensing unit (TRSE) to the gateway (GW) via the sender-receiver unit (TRSR).

The sender-receiver unit (TRSR) sends and receives data to and from the gateway (GW). For example, the sender-receiver unit (TRSR) may send sensor data in response to a control command sent from the gateway (GW), or may periodically send the sensor data, or may send the sensor data immediately after acquiring the sensor data. Furthermore, the sender-receiver unit (TRSR) may receive a control command sent from the gateway (GW). Based on the received control command, the modification of the control information concerning the terminal (TR) or the outputting to an output device in the input-output unit (TRIO) is performed. Moreover, the sender-receiver unit (TRSR) sends, as a control command, an item selected by the input device in the input-output unit (TRIO) to the gateway (GW).

The sensing unit (TRSE) senses a physical quantity indicative of a state of the terminal (TR). Specifically, the sensing unit (TRSE) comprises one or more sensors sensing various physical quantities. For example, the sensing unit (TRSE) includes, as the sensors used in sensing, the IR sender (TRIS), the IR receiver (TRIR), a temperature sensor (TRTE), a microphone (TRMI), an acceleration sensor (TRAC), and an illuminance sensor (TRIL).

The IR receiver (TRIR) senses an IR signal sent from the IR sender (TRIS) of other terminal (TR). As described later, the information of the sensed IR is used to determine whether or not the terminal (TR) has faced other terminal (TR).

The acceleration sensor (TRAC) senses the acceleration in the X, Y, and Z axis directions. As described later, the information of the sensed acceleration is used to determine an intensity of the movement or the behavior (e.g., walking, standing-still, or the like) of a person equipped with the terminal (TR).

The microphone (TRMI) senses voice. The sensed voice information may be used to determine whether or not a person equipped with the terminal (TR) is having a conversation, for example.

The temperature sensor (TRTE) and the illuminance sensor (TRIL) sense temperature and illuminance, respectively. The sensed temperature and illuminance information may be used to determine the current environment of the terminal (TR), for example.

The sensing unit (TRSE) may comprise any one or more of the above-described sensors, or may comprise other type of sensor. Furthermore, the sensing unit (TRSE) may introduce a new sensor by using an external input (TROU).

In addition, as previously described, the terminal (TR) may determine the contact status by exchanging a radio signal other than the IR signal. In that case, the sensing unit (TRSE) may include a radio signal receiver other than the infrared sensor (TRIR). Alternatively, the radio-signal receiver other than the infrared sensor (TRIR) may be connected to the external input (TROU).

The input-output unit (TRIO) includes an input device, such as a button, and an output device, such as a liquid crystal display, and acquires information, which a target person desires, and displays the sensor data. As the input-output unit (TRIO), a touch panel that is an integrated input device and output device may be used.

The control unit (TRCO) includes a CPU (not illustrated). The CPU executes a program stored in the recording unit (TRME), whereby the acquisition timing of sensor information, the analysis on the sensor information, and the send/receive timing to/from the gateway (GW) are controlled.

The recording unit (TRME) includes an external recording device, such as a hard disk, a memory, or an SD card, to store the program and the sensor data. Furthermore, the recording unit (TRME) includes a data format (TRDFI) and an internal information unit (TRIN).

The data format (TRDFI) specifies, in sending the data and time information acquired from each sensor, a format for summarizing these data.

The internal information unit (TRIN) stores the information on the terminal (TR). Example of the information on the terminal (TR) includes a battery monitor (TRBA), a watch (TRTI) (i.e., time information), and terminal information (TRTR).

The amount of remaining battery power of the terminal (TR) is recorded on the battery monitor (TRBA). The current time measured by a timer contained in the terminal (TR) is stored in the watch (TRTI). The current time is adjusted based on the one periodically sent from the gateway (GW). The terminal information (TRTR) is the information unique to a terminal used to identify the terminal (TR), and is also referred to as a unique ID.

By periodically making adjustment using the time of the gateway (GW) as the time of the terminal (TR), the time is synchronized across a plurality of terminals (TR). Accordingly, the data obtained from different terminals can be aligned with each other and checked based on the time. Since communication is always performed by a plurality of members, it is essential to synchronize time in order to analyze data from view points of both members. Note that, with regard to the time adjustment, instead of triggering the gateway (GW), the sensor net server (SS) may serve as a trigger to send time to the terminal (TR) via the gateway (GW).

### <Gateway>

The gateway (GW) is located in an area, where information is desired to be acquired, and receives sensor data sent by air from the terminal (TR) in this area and sends the received sensor data to the sensor net server (SS) via the network (NW). The gateway (GW) includes a sender-receiver unit (GWSR), a control unit (GWCO), an input-output unit (GWIO), a recording unit (GWME), and a internal information unit (GWIN).

FIG. 1 further illustrates two gateways of a gateway 2 (GW2) and a gateway 3 (GW3). Since the description of these gateways is the same as that of the gateway (GW), the description thereof is omitted hereinafter. Accordingly, the following description is established even if the gateway (GW) is replaced with either of the gateway 2 (GW2) and the gateway 3 (GW3). Note that the present invention may be applied even when there are an arbitrary number of similar gateways. Either of the gateways establishes connection with a plurality of terminals (TR) existing within a wireless service area and exchanges data.

The sender-receiver unit (GWSR) sends and receives data to and from the terminal (TR). For example, the sender-receiver unit (GWSR) may send a control command to the terminal (TR), or may periodically receive sensor data from the terminal (TR), or may receive sensor data from the terminal (TR) immediately after the terminal (TR) received the sensor data. Furthermore, the sender-receiver unit (GWSR) may send a request to the sensor net server (SS) in accordance with the control command sent from the terminal (TR), and may send data, which is acquired from the sensor net server (SS) in accordance with this request, to the terminal (TR). Moreover, the sender-receiver unit (GWSR) may send, as a control command, an item selected by an input device in the input-output unit (GWIO) to the terminal (TR) or to the sensor net server (SS). On the contrary, the sender-receiver unit (GWSR) may receive a control command sent from the sensor net server (SS) or the terminal (TR). The display on the output device is changed in accordance with the received control command.

The control unit (GWCO) includes a CPU (not illustrated). The CPU executes a program stored in the recording unit (GWME), whereby the acquisition timing of sensor information, the analysis on the sensor information, and the transmission and reception timing to the terminal (TR) or to the sensor net server (SS) are controlled.

The input-output unit (GWIO) includes an input device, such as a button or a keyboard, and an output device, such as a liquid crystal display, and displays the information and sensor data, such as the condition of the target area. As the input-output unit (GWIO), a touch panel that is an integrated input device and output device may be used.

The recording unit (GWME) includes an external recording device, such as a hard disk, a memory, or an SD card, to store a program and sensor data. Furthermore, the recording unit (GWME) includes a data format (GWDFI) and an internal information unit (GWIN).

The data format (GWDFI) is a format of the data and time information received from the terminal (TR), and the data is discriminated as each element based on this format.

The internal information unit (GWIN) stores the information regarding the gateway (GW). The information regarding the gateway (GW) includes, for example, a watch (GWTI) (i.e., time information), and gateway information (GWBA) which is the information unique to the gateway.

### <Network>

The network (NW) is a network for connecting the gateway (GW), the sensor net server (SS), the application server (AS), and the client (CL) to each other. The network (NW) may be a Local Area Network (LAN), Wide Area Network (WAN), or any other network.

### <Sensor Net Server>

The sensor net server (SS) stores sensor data sent from the gateway (GW), and also sends the sensor data based on a request from the application server (AS). Moreover, the sensor net server (SS) receives a control command from the gateway (GW), and sends a result obtained by this control command to the gateway (GW).

The sensor net server (SS) includes a database unit (SSDB), a control unit (SSCO), a sender-receiver unit (SSSR), an input-output unit (SSIO), and a recording unit (SSME).

The database unit (SSDB) stores sensor data sent from the terminal (TR) via the gateway (GW). Furthermore, the database unit (SSDB) stores a method for processing a control command from the gateway (GW). The database unit (SSDB) may be stored in a hard disk (not illustrated) which the later-described recording unit (SSME) includes.

The control unit (SSCO) includes a CPU (not illustrated). The CPU executes a program stored in the recording unit (SSME), thereby managing the database unit (SSDB) and processing the information sent from the application server (AS) and gateway (GW).

The sender-receiver unit (SSSR) sends data to the gateway (GW) and application server (AS) and receives data therefrom. Specifically, the sender-receiver unit (SSSR) receives sensor data sent from the gateway (TR) and sends the sensor data to the application server (AS). Moreover, upon receipt of a control command from the gateway (GW), the sender-receiver unit (SSSR) sends a result selected from the database unit (SSDB) to the gateway (GW).

The input-output unit (SSIO) includes an input device, such as a button or a keyboard, and an output device, such as a liquid crystal display, and displays the information and sensor data, such as the condition of a target area. As the input-output unit (SSIO), a touch panel which is an integrated input device and output device may be used.

The recording unit (SSME) includes an external recording device, such as a hard disk, a memory, or an SD card, to store a program and sensor data. Furthermore, the recording unit (SSME) includes a data format (SSDFI).

The data format (SSDFI) is a format of the data and time information received from the gateway (GW), and the data is discriminated as each element based on this format and is classified into an appropriate element of the database unit (SSDB).

### <Application Server>

The application server (AS) is a computer that processes the sensor data stored in the sensor net server (SS). The application server (AS) includes a data processing unit (ASDP), a control unit (ASCO), a recording unit (ASME), a sender-receiver unit (ASSR), and an input-output unit (ASIO). Note that the client (CL) or the sensor net server (SS) may serve as the application server (AS).

The data processing unit (ASDP) processes sensor data to create an image for expressing an organizational communication. The data processing unit (ASDP) calculates a contact matrix (APIM) and a contacting number and time (APIC), and plots data (APIP). If other processes are added as alternative embodiment, these processes are performed by the data processing unit (ASDP). The data processing unit (ASDP) stores the processed data temporarily in the recording unit (ASME).

The data processing unit (ASDP) may be achieved in such a manner that the CPU of the control unit (ASCO) executes a program stored in the recording unit (ASME), for example. In this case, the processings, such as the contact matrix calculation (APIM), the contacting number and time calculation (APIC), and the data plot (APIP), in the data processing unit are actually performed by the CPU of the control unit (ASCO).

The control unit (ASCO) includes a CPU (not illustrated). The CPU executes a program stored in the recording unit (ASME), and performs processings, such as data acquisition request to the sensor net server (SS), execution of data processing, control of the execution result, and the like.

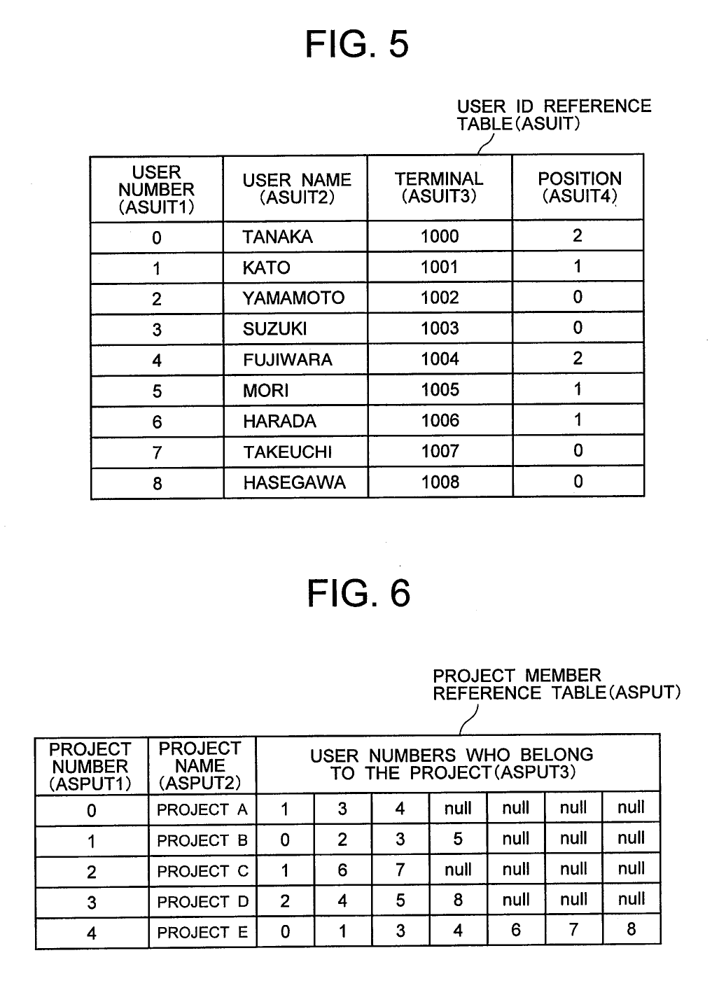

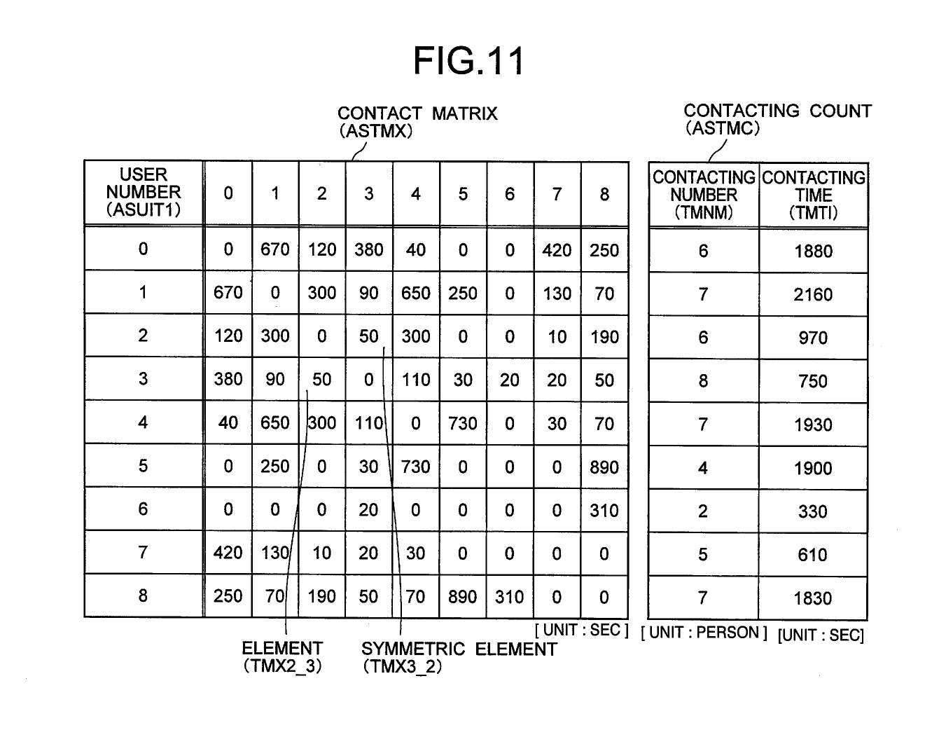

The recording unit (ASME) includes an external recording device, such as a hard disk, a memory, or an SD card, and stores a program, sensor data, and a processed result by the data processing unit (ASDP). Furthermore, the recording unit (ASME) records values, such as an initial condition setting (ASSII) and a connected table (ASCNT), which should be stored temporarily for processing. These values can be added, deleted or modified according to the type of data and the type of processing, as required. Moreover, the recording unit (ASME) records in advance a user ID reference table (ASUIT) indicative of a correspondence between the user (US) equipped with the terminal and the unique ID of the terminal, and a project member reference table (ASPUT) indicative of a correspondence between a project and the users (members) belonging thereto. The user ID reference table (ASUIT) and the project member reference table (ASPUT) may be recorded in the recording unit (SSME) in the sensor net server (SS) or in the recording unit (CLME) in the client (CL). Moreover, a contact matrix (ASTMX) is an array created by the contact matrix calculation (APIM). An example of the project member reference table (ASPUT) is shown in FIG. 5, an example of the user ID reference table (ASUIT) is shown in FIG. 6, and an example of the contact matrix (ASTMX) is shown in FIG. 11, respectively.

Although the user ID reference table (ASUIT) and the project member reference table (ASPUT) may be described directly in a program, only the reference tables may be separately stored so as to flexibly respond to a change in the users, a change of the terminal ID, a change in the organizational structure of a project, or the like.

The sender-receiver unit (ASSR) receives sensor data from the sensor net server (SS), and performs data transmission based on a request for a processed result from the client (CL).

The input-output unit (ASIO) may include an input device, such as a button or a keyboard, and an output device, such as a liquid crystal display, and displays the information and sensor data, such as the condition of a target area. As the input-output unit (ASIO), a touch panel which is an integrated input device and output device may be used.

### <Client>

The client (CL) sends a request to process data to the application server (AS) based on a request from a user, receives the processed result from the application server (AS), and displays the received processed result on a screen. The client (CL) includes an application unit (CLAP), a sender-receiver unit (CLSR), an input-output unit (CLIO), a recording unit (CLME), and a control unit (CLCO).

The control unit (CLCO) includes a CPU (not illustrated) that executes a program stored in a recording unit (CLME). The control unit (CLCO) adjusts the size and the like of an image received from the application server (AS) based on the request from a user, and provides the user with this result by displaying a created screen on the output device, such as the display (CLWD) of the input-output unit (CLIO). For example, this may be achieved in such a manner that the CPU of the control unit (CLCO) executes the program stored in the recording unit (CLME).

The sender-receiver unit (CLSR) sends to the application server (AS) a request to send the processed result of sensor data within the range specified by a user, and receives the processed result (i.e., an image or the sensor data processed by the application server (AS)).

The input-output unit (CLIO) includes input devices, such as a mouse (CLIM) and a keyboard (CLIK), and an output device, such as the display (CLWD), and displays the information and sensor data, such as the condition of a target area. As the input-output unit (CLIO), a touch panel which is an integrated input device and output device may be used. Moreover, an external I/O (CLOU) may be used in order to connect other I/O device.

The recording unit (CLME) includes an external recording device, such as a hard disk, a memory, or an SD card, to store a main program, sensor data, an image sent from the application server, and the processed result by the control unit (CLCO). Moreover, the recording unit (CLME) records, as an initial condition setting (CLISI), the condition such as the size of a screen established by a user.

### <Whole Sequence Diagram>

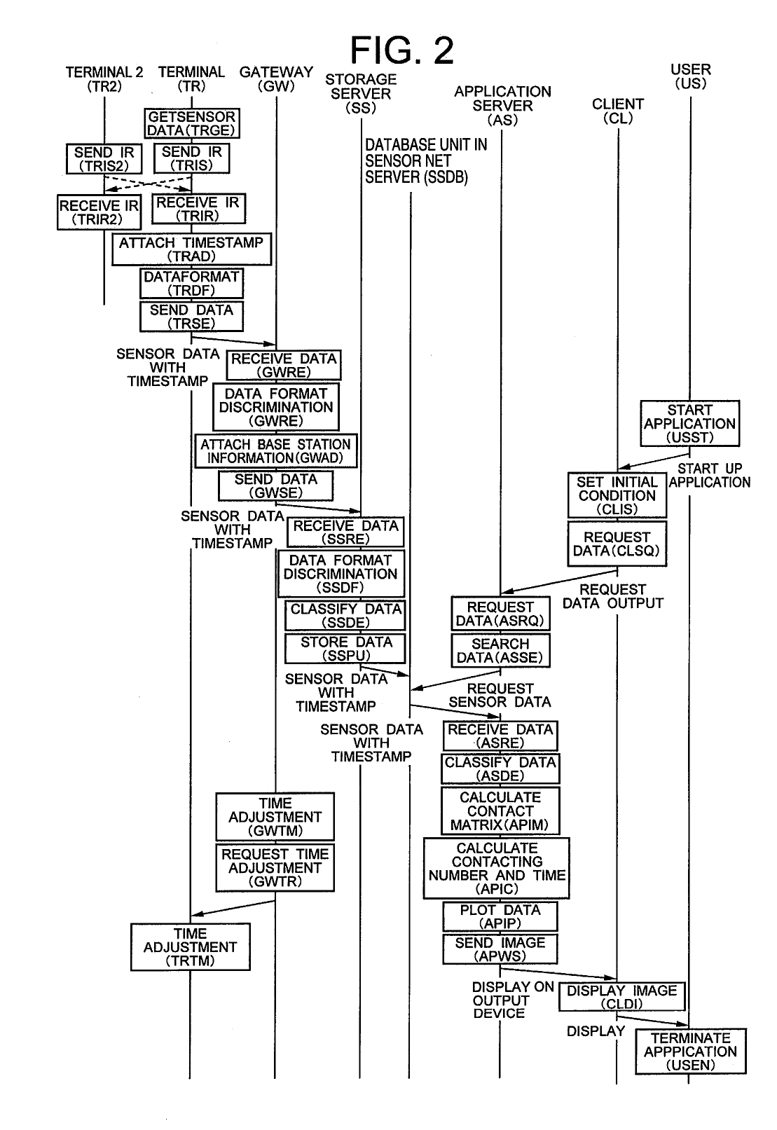

FIG. 2 is a sequence diagram showing the processings of sensor data provided from the terminal (TR) to the user (US), in the first embodiment of the present invention.

The sensor data acquired by the terminal (TR) is periodically delivered to the sensor net server (SS) via the gateway (GW) and stored in the database (SSDB). This flow corresponds to the step of getting sensor data (TRGE) to the step of storing data (SSPU) of FIG. 2. Moreover, the flow from time adjustment (GWTM) to time adjustment (TRTM) is executed in a different cycle from the flow of getting sensor data.

On the other hand, upon request from a user, the flow follows the steps below: a request is sent from the client (CL) to the sensor net server (SS) through the application server (AS); and from the acquired data an image is created in the application server (AS) and returned to the client (CL). This flow corresponds to the steps of starting an application (USST) to the step of terminating the application (USEN) in FIG. 2.

With regard to getting sensor data (TRGE), the information required to get sensor data, such as a sampling period and acquisition time, is described in the recording unit (TRME), and based on this information the sensing unit (TRSE) in the terminal (TR) performs sensing. Moreover, the terminal (TR) continues to send IR carrying information for discriminating the terminal (TR) itself, in a certain cycle, (TRIS). When the terminal (TR) faces other terminal 2 (TR2), i.e., when the users of the terminal (TR) and the terminal 2 (TR2) contact to each other, the terminal (TR) will receive IR (TRIS2) sent by the terminal 2, (TRIR). Moreover, in contrast, the IR sent by the terminal (TR) is received by the terminal 2 (TR2), (TRIR2). Depending on the conditions, such as an angle between the terminals, only one of the above-described IRs may be received. Furthermore, the terminal (TR) records the sensed data in the recording unit (TRME).

In the step of attaching time stamp (TRAD), the terminal (TR) records the time of the watch (TRTI) along with the sensor data, as the acquisition time of the sensed data. In the step of formatting data (TRDF), the terminal (TR) unifies the data into a data sending format with reference to the data format (TRDFI) in the recording unit (TRME).

In the step of sending data (TRSE), the terminal (TR) sends the sensor data sensed in the step of getting the sensor data (TRGE) to the gateway (GW) via the sender-receiver unit (TRSR). More specifically, the terminal (TR) converts the sensor data recorded on the recording unit (TRME), by the control unit (TRCO) using a sending format used for the gateway (TR) stored in the recording unit (TRME). Then, the terminal (TR) sends the sensor data, which is converted into the sending format, to the gateway (GW) via the sender-receiver unit (TRSR).

In the step of receiving data (GWRE), the gateway (GW) receives the sensor data, which is sent in the sending format used for the gateway (GW) from the sender-receiver unit (TRSR) of the terminal (TR), by the sender-receiver unit (GWSR). The received sensor data is stored in the recording unit (GWME).

In the step of discriminating data formats (GWDF), the gateway (GW) discrimintates the formats of data by comparing the format of the acquired data with the data format (GWDFI) of the recording unit (GWME). Furthermore, the gateway (GW) adds the gateway information (GWBA) to an appropriate position indicated by the data format (GWDFI), in the step of attaching gateway information (GWAD).

In the step of sending data (GWSE), the gateway (GW) sends the sensor data stored in the recording unit (GWME) to the sensor net server (SS) via the sender-receiver unit (GWSR). More specifically, the control unit (GWCO) of the gateway (GW) converts the sensor data recorded in the recording unit (GWME) into a sending format used for the sensor net server (SS) stored in the recording unit (GWME). Then, the gateway (GW) sends the sensor data, which is converted into the sending format, to the sensor net server (SS) via the sender-receiver unit (GWSR).

In the step of receiving data (SSRE), the sender-receiver unit (SSSR) of the sensor net server (SS) receives the sensor data, which is sent in the sending format used for the sensor net server (SS) from the sender-receiver unit (GWSR) of the gateway (GW). The received sensor data is stored in the recording unit (SSME).

In the step of discriminating data formats (SSDF), the sensor net server (SS) discriminates the formats of data by comparing the format of the acquired data with the data format (SSDFI) of the recording unit (SSME). Furthermore, in the step of classifying data (SSDE), the sensor net server (SS) classifies each data for each element.

In the step of storing data (SSPU), the control unit (SSCO) of the sensor net server (SS) converts sensor data into a format of the database unit (SSDB). The converted sensor data is stored in the database unit (SSDB). A method for storing data to the database unit (SSDB) is preferably made so as to be used as an effective query in searching the data later. Examples of the effective query include a sensor-data name, time, a unique terminal ID, and a unique gateway ID.

A series of processes from getting sensor data (TRGE) to storing data (SSPU) are carried out periodically.

The time adjustment (GWTM) is performed to adjust the time of the watch (GWTA) of the gateway (GW). The gateway (GW) acquires the current time from an NTP server (not illustrated) existing in the network (NW). The process of time adjustment (GWTM) is carried out periodically.

A time adjustment request (GWTR) is requested from the gateway (GW) to the terminal (TR) in order to adjust the time of the terminal (TR). The time adjustment (TRTM) is a process to adjust the time of the watch (TRTI) based on the time, which is sent from the gateway (GW) in accordance with the time adjustment request (GWTR). The processes from the time adjustment request (GWTR) to the time adjustment (TRTM) are carried out periodically.

Next, the sensing interval in the sensing unit (TRSE) of the terminal (TR) and the sending timing in the sender-receiver unit (TRSR) are described taking one of the examples in the present embodiment.

The terminal (TR) includes a triaxial acceleration sensor and an IR transceiver, all of which perform the sensing and data transmission in a cycle of 10 sec.

The acceleration sensor performs the sensing 100 times for each of the X, Y, and Z axis directions in the first 2 sec during 10 sec. The acceleration information obtained as a result of sensing indicates a state of the terminal (TR).

When the terminal (TR) is attached to a person, the obtained acceleration information indicates a state of the activity of the person equipped with this terminal (TR) (e.g., whether or not this person remains stationary).

The IR sender sends an IR signal toward the front face of the terminal (TR) six times per 10 sec. The IR signal to be sent includes terminal information (TRTR), i.e., a signal indicative of the ID (identifier) of the terminal (TR) itself.

When two terminals (TR) faces to each other, namely, when two persons contact to each other), the receiver of one terminal (TR) will receive the ID of the other terminal (TR). Namely, when one terminal (TR) has received the ID of the other terminal (TR), this means that these two terminals are currently facing to each other. Namely, in the case where the respective terminals (TR) are attached to the front faces of the persons, that two terminals (TR) are facing to each other means that two persons equipped with these terminals are contacting to each other. The receiver side of IR is always in a standby state and records the ID received during 10 sec and the number of times of reception.

Then, the terminal (TR) attaches a time stamp and terminal information (TRTR), i.e., its own unique ID to these sensor data, and then sends these sensor data collectively by air to the gateway (GW). As a result, in the above-described example, the sensor data sent from the terminal (TR) includes the information indicative of the acceleration of this terminal, the unique ID of this terminal, the information indicating that this terminal faced to other terminal, and the time information associated with these information. These sensor data are used as the interaction data indicative of the interaction between persons.

However, the above is just an example, and the sensing interval and sending timing can be set arbitrarily.

In the step of starting an application (USST), the application of the client (CL) is started by the user (US).

In the step of setting an initial condition (CLIS), the client (CL) sets the information required to present diagrams. The user (US) selects a button and thereby acquires the time of the data to be displayed, the terminal information, and the condition setting of a display method, and the like. The condition established here is stored in the recording unit (CLME).

In the step of requesting data (CLSQ), the client (CL) performs a request for data or an image to the application server (AS) based on the initial condition setting (CLIS). The information, including the name, address, and the like of the application server (AS) to be searched, required to acquire sensor data is stored in the recording unit (CLME). The client (CL) creates a data request command, which is then converted into the sending format used for the application server (AS). The command converted into the sending format is sent to the application server (AS) via the sender-receiver unit (CLSR).

In the step of requesting data (ASRQ), the application server (AS) receives a request from the client (CL), and furthermore requests the sensor data by sending to the sensor net server (SS) a range of the time of the data to be acquired and the unique ID of a terminal for which data is acquired. The time and terminal unique ID to be sent may be automatically set based on those stored in the recording unit (ASME) of the application server (AS) or in the recording unit (CLME) of the client (CL), or may be those which the user (US) specifies through the input-output unit (CLIO) of the client (CL).

In the step of searching data (ASSE), the application server (AS) searches the sensor net server (SS) based on the data request (ASRQ). In the recording unit (ASME), the information, such as the name and address of the sensor network (SS) to be searched, the data base name, the table name, and the like, required to acquire a data signal are described. In performing data search (ASSE), the application server (AS) requests a search content through the data request (ASRQ), and acquires the information on the database from the recording unit (ASME), and creates a command used in the search. The created command is converted into the sending format used for the sensor net server (SS) stored in the recording unit (ASME), by the control unit (ASCO). The command converted into the sending format is sent to the sensor net server (SS) via the sender-receiver unit (ASSR).

The database (SSDB) in the sensor net server (SS) executes the received command to query, and sends the data to the application server (AS).

In the step of receiving data (ASRE), the application server (AS) receives sensor data sent from the database unit (SSDB) in the sensor net server (SS) based on the command to search data (ASSE). The sensor data received by the sender-receiver unit (ASSR) is stored in the recording unit (ASME).

In the step of classifying data (ASDE), the application server (AS) classifies the acquired data into each appropriate element. In this case, the time information and sensor data are always classified while being associated to each other.

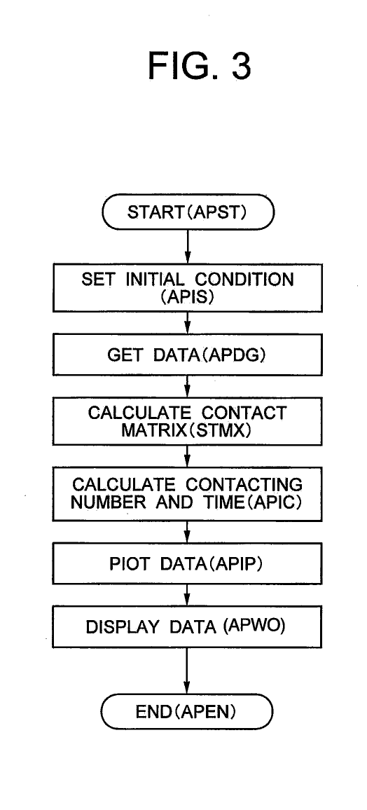

The flow from the step of requesting data (CLSQ) to the step of classifying data (ASDE) corresponds to the data acquisition (APDG) in a flowchart of FIG. 3.

Subsequently, the respective processes to calculate a contact matrix (APIS), to calculate a contacting number and time (APIC), and to plot data (APIP) are carried out sequentially. The detailed contents of these processes will be shown in the flowcharts of FIG. 3 and thereafter. The programs for performing these processes are stored in the recording unit (ASME), and are executed by the data processing unit (ASDP) to create an image.

The image is sent to the client in the step of sending an image (APWS), and is displayed on the output device, e.g., the display (CLWD) of the client (CLDI).

In the final step of terminating an application (USEN), the user (US) terminates the application.

### <Overall Flowchart>

FIG. 3 is a flowchart showing a brief process flow from starting an application until a display screen is provided to the user (US), in the first embodiment of the present invention.

In order to create a display screen, each of the steps of starting the application (APST), setting an initial condition (APIS), getting data (APDG), calculating a contact matrix (APIM), calculating a contacting number and time (APIC), plotting data (APIP), and displaying data (APWO) is sequentially executed, and then the flow will end (APEN). Each process is described one by one in detail.

### <Flowchart of Setting Initial Condition>

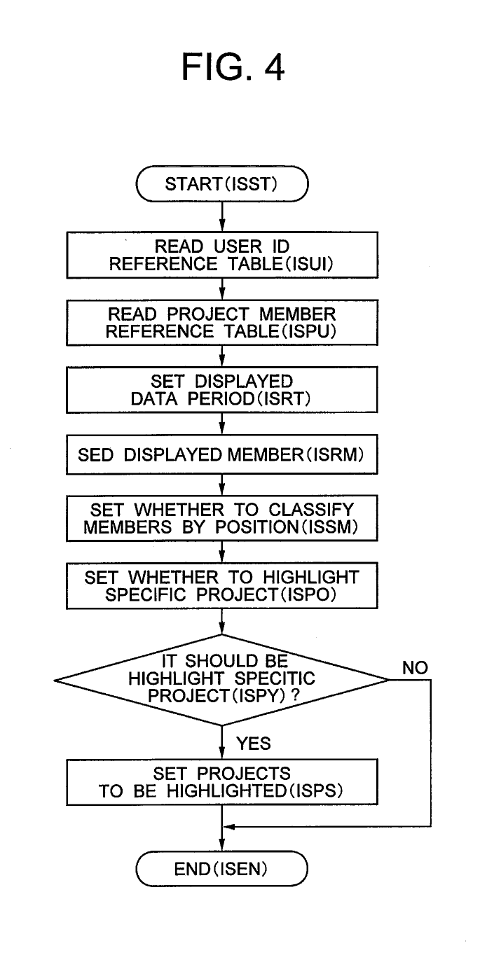

The process to set an initial condition (APIS) are shown in a flowchart of FIG. 4.

In setting an initial condition (APIS), the steps of starting an application (ISST), reading a user ID reference table (ISUI), reading a project member reference table (ISPU), setting a displayed data period (ISRT), setting displayed members (ISRM), setting whether to classify members by position (ISSM), and setting whether to highlight a specific project (ISPO) are performed, and furthermore, if the answer of “Should a specific project be highlighted? (ISPY)” is yes, the project to be highlighted is set (ISPS).

In the step of reading a user ID reference table (ISUI), as an example, the user ID reference table (ASUIT) as shown in FIG. 5, is read, in which a terminal's unique ID (ASUIT3) is associated one-to-one with the user name (ASUIT2) of a user equipped with this terminal. A user number (ASUIT1) to be used in processing later is assigned to a user in advance. A column indicative of a position (ASUIT4) is also prepared, as required. In the example of FIG. 5, a department manager is numerically expressed as 2, a section chief as 1, and a regular employee as 0. A way how to classify members by position may be set arbitrarily. When there is a change in the members, positions, and the like in an organization, this change can be handled by rewriting only the user ID reference table (ASUIT).

In the step of reading a project member reference table (ISPU), as an example, as shown in FIG. 6, the project member reference table (ASPUT) for associating the name of a project existing in an organization with the members belonging thereto is read. Note that, hereinafter, all sub-organizations, such as a fixed organization, such as a group, a unit or the like, relative to an entire organization, such as a department, a section, or the like, or a flexibly changing organization such as a project, shall be collectively referred to as projects.

Since the project member reference table (ASPUT) just needs to clarify who belongs to which project, a form may be employed wherein the project member reference table is combined with the user ID reference table (ASUIT), and wherein there is a column for writing a project name which a user expressed by each line belongs to. Moreover, if it is not necessary to classify the display in accordance with a project, the project member reference table (ASPUT) is not required. In the project member reference table (ASPUT) of FIG. 6, the case where a member concurrently belongs to a plurality of projects is handled, but this is not necessarily handled. The project member reference table (ASPUT) includes the items of a project name (ASPUT2) and “user numbers who belong to the project” (ASPUT3). Moreover, a project number (ASPUT1) to be used in processing later is assigned to each project. The number in the item of the “user numbers who belong to the project” (ASPUT3) corresponds to the user number (ASUIT1) in the user ID reference table (ASUIT). The project member reference table (ASPUT) may be separately prepared from a program body, so that when there is a change in the membership of a project, this change can be easily handled by rewriting only the project member reference table (ASPUT). However, the project member reference table (ASPUT) may be described directly in the program body.

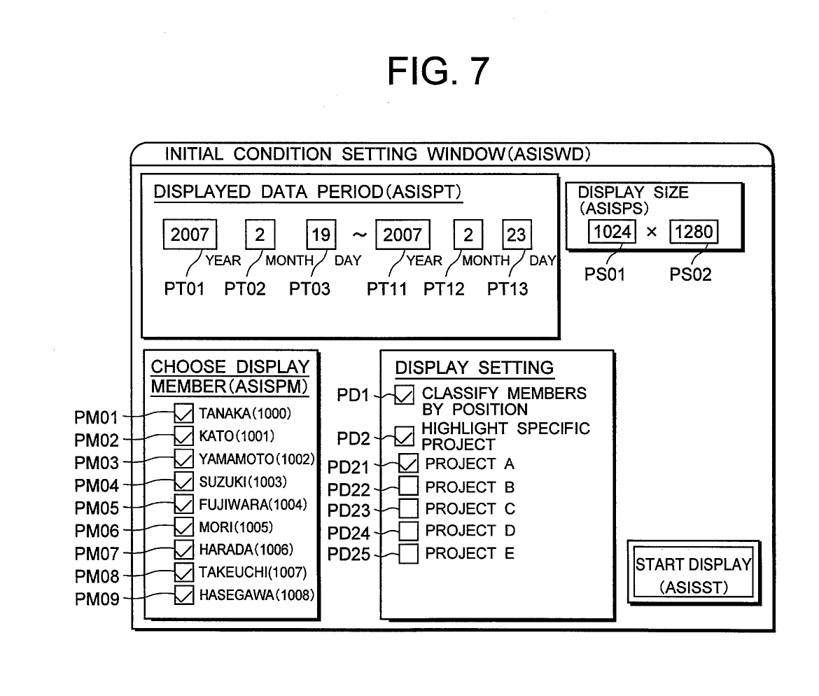

In the steps of setting a displayed data period (ISRT), setting a displayed data period (ISRM), setting whether to classify members by position (ISSM), and setting whether to highlight specific project (ISPO), for example, an initial condition setting window (ASISWD) as shown in FIG. 7 is displayed on the output device, such as the display (CLWD), of the client (CL), whereby the respective settings are carried out by prompting the user (US) to input data using the input device, such as the mouse (CLIM) or the keyboard (CLIK). The initial condition setting window (ASISWD) may be stored in the client (CL) from the beginning.

In the step of setting a displayed data period (ISRT), dates are set in text boxes (PT01 to 03, PT11 to 13) in the field of “choose displayed data period” (ASISPT) on the window, and then data, for which the time when acquired by the terminal (TR) falls within this range, shall be used in calculation for the display. A step of setting a time range may be added, as required.

The step of setting a displayed data period (ISRM) is carried out in the field of “choose display member” (ASISPM) on the window. On the window, all the user names read in the step of reading the user ID reference table (ISUI), and furthermore the terminal ID, as required, will be reflected. The user (US) sets which member's data is to be displayed by checking the check boxes (PM01 to PM09) or by not checking these. Instead of directly designating the individual member, the displayed members may be collectively designated in the unit of predetermined group, or in accordance with the conditions, such as age.

The steps of setting whether to classify members by position (ISSM) and setting whether to highlight specific project (ISPO) are carried out in the field of “display setting” (ASISPD) on the window. When a check box (PD1) of “classify members by position” is checked, the members are plotted with different symbols, such as a square, a circle, and the like, depending on the position, in the display. This check box is used when a user desires to verify a difference in how to perform communication depending on positions. If a check box (PD2) of “highlight specific project” is checked, then in the display, a symbol corresponding to a member belonging to a specific project is highlighted, in such a manner that the area thereof is filled, relative to other symbols and is displayed. This check box is used when a user desires to verify how what kind of communication is performed per project.

Furthermore, if the check box (PD2) is checked, then in the flowchart of FIG. 4, the answer of “Should a specific project be highlighted?” (ISPY) is yes and the step of setting projects to be highlighted is carried out (ISPS). The step of setting projects to be highlighted (ISPS) is carried out in such a manner that a user checks the check boxes (PD21 to PD25), on which each project name read from the project member reference table (ASPUT) is reflected. The number of checks may be limited to one or may be more than one.

In the field of a display size (ASISPS), the size of an image to be displayed is set. In the present embodiment, assume that an image to be displayed on a screen is rectangular. The vertical length of the image is inputted to a text box (PS01), and the horizontal length is inputted to a text box (PS02). As the unit of numeric value to be inputted, a certain unit of length, such as pixel or cm, is designated.

If all the data are inputted, then, finally, the above-described initial conditions are determined in such a manner that the user (US) pushes a display start button (ASISST), and then the flow proceeds to the step of getting data (APDG) in FIG. 3.

<Flowchart from Step of Getting Data to Step of Calculating Contact Matrix>

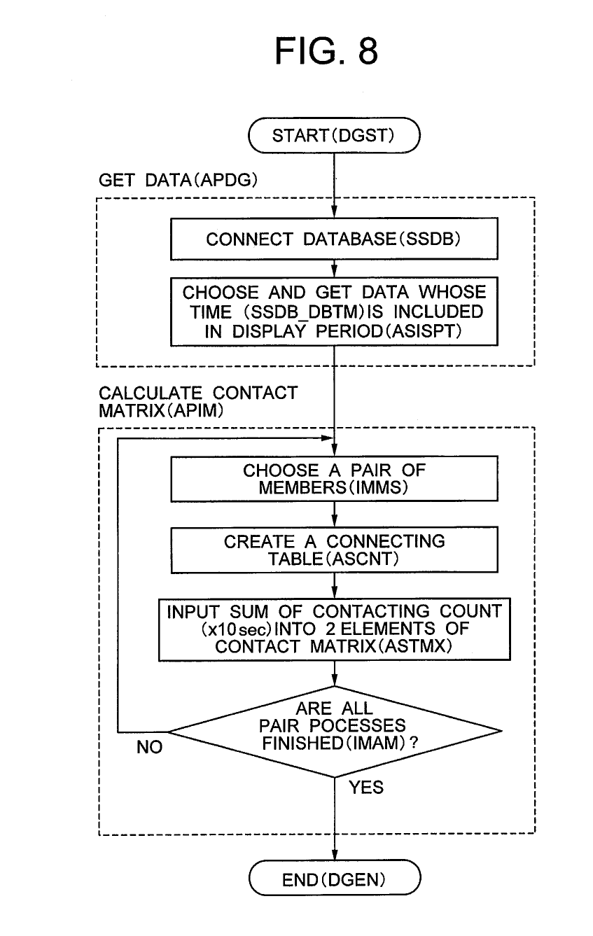

FIG. 8 is a flowchart showing the details of the steps of getting data (APDG) and calculating a contact matrix (APIM) of FIG. 3, in the first embodiment of the present invention.

After the start (DGST), the steps of getting data (APDG) and calculating a contact matrix (APIM) are carried out and then the flow comes to an end (DGEN). The step of getting data (APDG) is a process to get necessary data from the database unit (SSDB) in the sensor net server (SS).

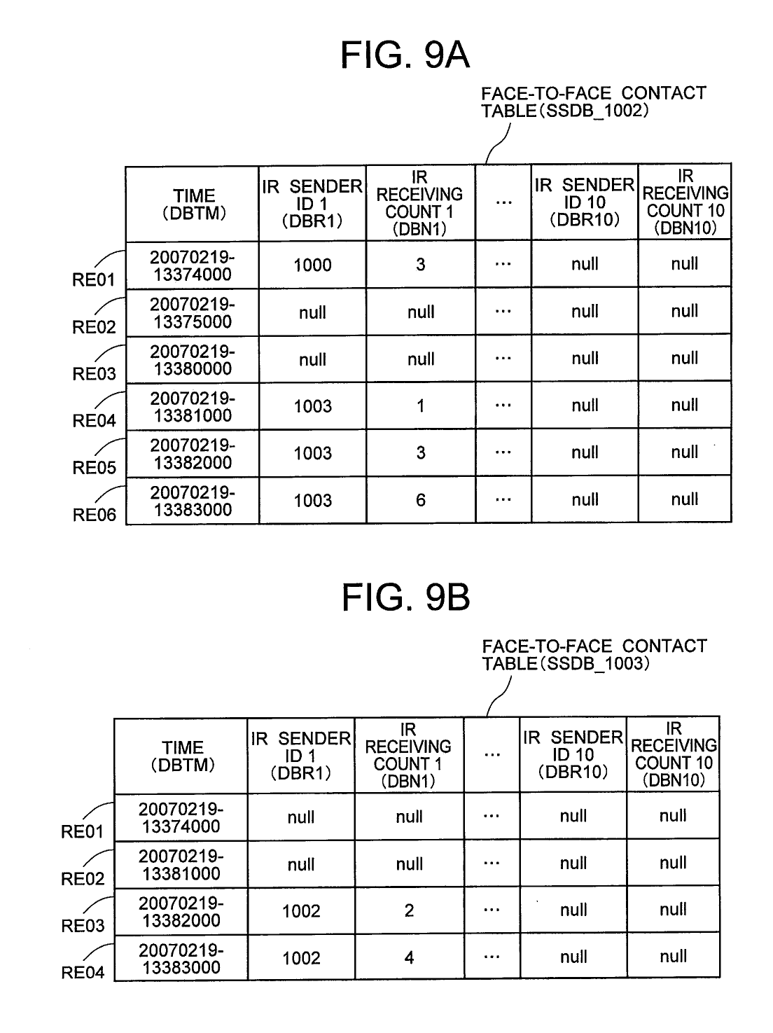

Although a plurality of types of sensor data for a plurality of members are recorded in the database unit (SSDB), among them an example of the table summarizing face-to-face contact data that are obtained sending and receiving IR is shown in FIG. 9A, 9B. FIG. 9A is a face-to-face contact table (SSDB_1002), which is assumed to be a table having collected data obtained from the terminal (TR) with the terminal ID of 1002. Similarly, FIG. 9B is a face-to-face contact table (SSDB_1004), which is assumed to be a table having collected data obtained from the terminal (TR) with the terminal ID of 1003. Note that the tables may not be split per the obtained terminal ID, and other data, such as acceleration and temperature data, may be included in the same table, as well.

The face-to-face contact table can store 10 sets (DBR1 to DBR10, DBN1 to DBN10) of a time instant (DBTM) when the terminal (TR) sent data, an IR sender ID (DBR1), and an IR receiving count (DBN1). Since here, data transmission is carried out once per 10 sec, the table indicates how many times IR has been received from which terminal (TR) in 10 sec after the last transmission. This means that up to 10 sets of data can be stored even when having contacted to a plurality of terminals (TR) during 10 sec. Note that the number of sets of data can be set arbitrarily. When there has been no face-to-face contact, i.e., no receipt of IR, the data is stored as null. Moreover, in FIG. 9, the time is written down to the unit of mS. Any form of time can be used as long as it is unified.

In the step of getting data (APDG) of FIG. 8, first, a user connects to the database unit (SSDB) of the sensor net server (SS), (DGCD), and creates an SQL command based on the conditions of the displayed data period (ASISPT) and the displayed member (ASISPM) established in the above-described initial condition setting (APIS), and then from the database (SSDB), a user acquires the data, of which time (DBTM) is included in the established displayed-data period, from the face-to-face contact table of all the members to be displayed (DGSG).

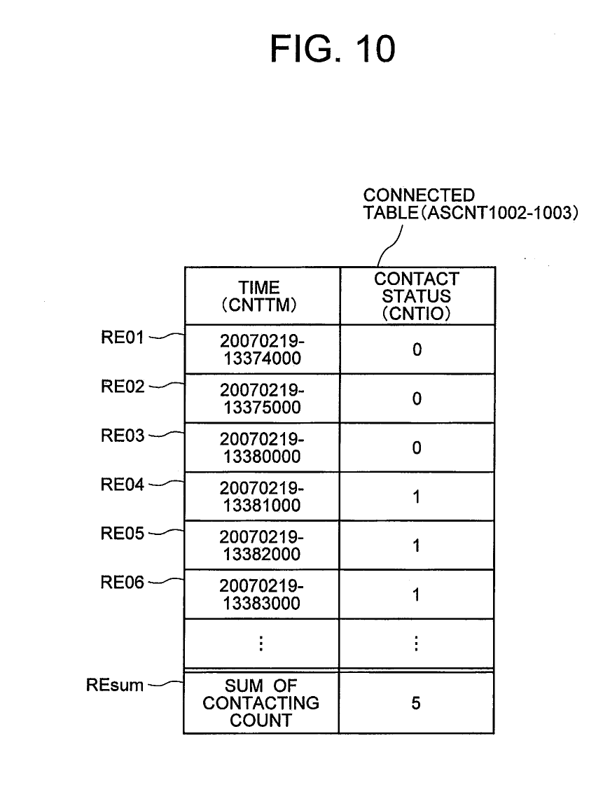

In the step of calculating a contact matrix (APIM), one pair (two persons) is chosen from the members to be displayed (IMMS), and then the time instants of the two persons' data are aligned to each other to create a connected table (IMAD). An example of the connected table created from the data of the No. 1002 terminal (TR) of FIG. 9A and the data of the No. 1003 terminal (TR) of FIG. 9B is the connected table (ASCNT 1002 to 1003) of FIG. 10. In creating the connected table (IMAD), the time instants between the respective face-to-face contact tables (DBTM) are aligned to each other to be set as the time instant of the connected table (CNTTM). Moreover, as in the first line (RE01) and the second line (RE02) of FIG. 9B, when there is no data input in the sensing cycle (here, 10 sec interval), the data will be complemented. Moreover, if the time instants of two face-to-face contact tables do not match with each other completely, then, for example, either one of them is aligned with the other, or the time instant completely in the unit of 10 sec is set and two pieces of data close to this established time instant are treated as each having the same time instant, thereby comparing the lines that can be regarded as having the same time instant. Meanwhile, when the face-to-face contact data between the established two terminals (TR) exists in at least one of the face-to-face contact tables, two members are considered to have contacted to each other at this time instant, and the column of the contact status (CNTIO) of the connected table is set to 1. Otherwise, it is set to 0. The connected table is created in this manner. Furthermore, the number of times of occurrence of contact at all time instants are summed.

For the criteria for determining that the contact has occurred, other criteria, such as only when the IR receiving count is equal to or greater than a threshold, may be used. Moreover, with the connected table, a sum of contacting counts (REsum) just needs to be calculated, and therefore without creating the table, the contacting count may be counted while aligning the time instances.

Next, the value of the calculated sum of contacting count is multiplied by 10 and put into two elements indicative of the two chosen members of the contact matrix (ASTMX), (IMCI). It is the object of the ten times multiplication to regard the summed contacting count of 1 as having contacted for 10 sec and align the units of values of the contact matrix with the unit of second. If not required, the units of the values may not be aligned.

FIG. 11 shows an example of the contact matrix (ASTMX). The row and column correspond to the user number (ASUIT1) in the user ID reference table (ASUIT), respectively. In this case, since the user number with the terminal ID of No. 1002 is 2 and the user number with the terminal ID of No. 1003 is 4, a value is put in an element (TMX2_3). Moreover, with regard to the face-to-face contact, if one of the members has contacted, the other is naturally considered to have contacted as well, and therefore the same value is put in a symmetry element (TMX3_2) as well so that the contact matrix (ASTMX) may be a symmetric matrix. However, the contact matrix (ASTMX) may be a asymmetric matrix, if intended to be so.

Once the elements of the contact matrix (ASTMX) for a pair of members are filled in, another pair is chosen, which is repeated until the processes for all pairs are finished (IMAM).

### <Count of Contacting Time and Number>

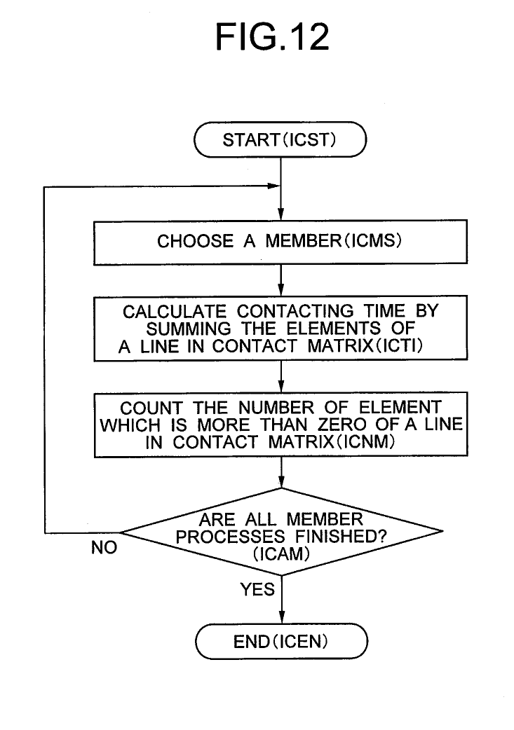

FIG. 12 is a flowchart showing the details of the step of calculating the contacting number and time (APIC) of FIG. 3, in the first embodiment of the present invention.

In the steps from start (ICST) to end (ICEN), the contacting time is summed and the contacting number is counted for each member.

First, one member is chosen (ICMS), and a line corresponding to the user number (ASUIT1) of this member is determined in the contact matrix (ASTMX). Next, the elements of a line in the contact matrix are summed. The result of this summation is the contacting time (TMTI) of the contacting count (ASTMC) of FIG. 11 (ICTI). Namely, the contacting time (TMTI) is a total time that the relevant member has communicated with some persons within the established displayed-data period (ASISPT), and can be regarded as the amount of communication. Moreover, the number of elements having a positive value (i.e., more than zero) of a line in the contact matrix (ASTMX) is counted and the resultant count is set to the contacting number (TMNM) of the contacting count (ASTMC) of FIG. 11, (ICNM). The contacting number is the number of other persons whom the relevant member has associated with in the displayed data period (ASISPT), and can be viewed as a diversity of the relation which this member has.

Note that although the contacting count (ASTMC) of FIG. 11 is in the form of a table, in which the contacting number (TMNM) and the contacting time (TMTI) are combined, a format other than the table may be used if the values of the contacting number and the contacting time corresponding to each member is clear-cut.

The above-described procedures of summing the contacting time (ICTI) and counting the contacting number (TCNM) are repeated until the processes for all the member are finished (ICAM).

### <Flowchart of Data Plot>

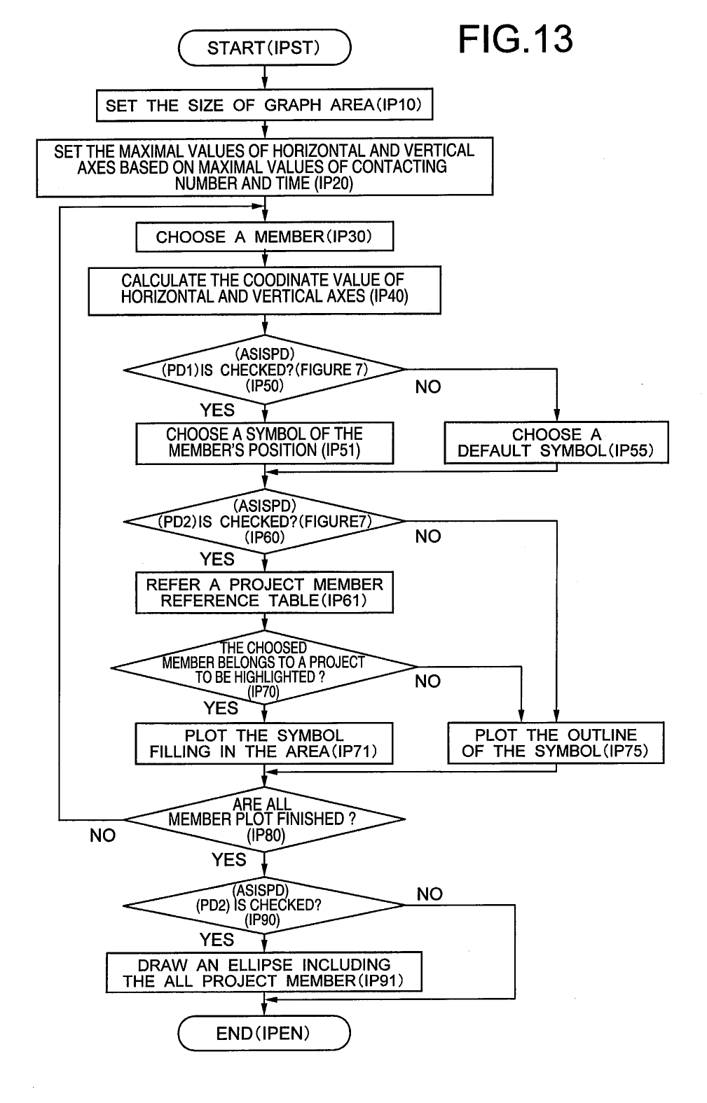

FIG. 13 is a flowchart showing the details of the step of plotting data (APIP) of FIG. 3, in the first embodiment of the present invention.

In the step of plotting data (APIP), each member is plotted on a coordinate, in which the counted contacting number (TMNM) and contacting time (TMTI) are taken on the horizontal axis and the vertical axis, respectively. In this case, based on the items established in the initial condition setting (APIS), the shape of a symbol to be plotted, whether or not to fill the symbol, and the like are determined for each member.

After starting the step of plotting data (IPST), the size of a graph area is determined, first (IP10). The size of a graph area is the size of an area, which the graph of the display screen occupies, and is calculated so as to be the value obtained by subtracting, from the display size (ASISPS) established on the initial condition setting window (ASISWD), the areas for the titles, values of the axes, and space portions in the vertical and horizontal directions, respectively.

Next, the respective maximal values of the vertical and horizontal axes are set (IP20). Here, with reference to the respective maximal values of all the data to be plotted, i.e., the contacting number (TMNM) and the contacting time (TMTI) of the contacting count (ASTMC) of FIG. 11, the values of the axes are set so as to be convenient numbers larger than the maximal values. When there is an outstanding high value as compared to other values, a value smaller than the maximal value of the contacting count (ASTMC) may be taken as the maximal value of the axis. Moreover, an ordinary axis (with equal difference scale), which is scaled so that each axis may be in the form of an arithmetical progression, is assumed, here. However, depending on a distribution of the contacting number (TMNM) or contacting time (TMTI), either or both of the axes may be a logarithmic axis (logarithmic scale).

Next, one member is chosen, and then a coordinate value to be plotted is determined, on the basis of the scale determined earlier, from the data of the contacting number (TMNM) and contacting time (TMTI) of the contacting count (ASTMC) corresponding to the relevant user number (ASUIT1), (IP40).

Furthermore, if the “classify members by position” check box (PD1) is checked in the display setting (ASISPC) in the step of setting the initial condition (APIS), (IP50), then the relevant member's position (ASUIT4) is extracted from the user ID reference table (ASUIT), and a symbol corresponding to the position is chosen (IP51). The symbol is the one for classifying positions at the time of plotting, and is pre-set, e.g., a square for a department manager, a triangle for a section chief, and a circle for a regular employee. In the case where the classification of members by position is not performed, a symbol set as default is used (IP55). In order to classify members by position, a method other than the method of changing the symbols to be plotted may be employed.

Moreover, if the “highlight specific project” check box (PD2) is checked in the display setting (ASISPC) of the step of setting the initial condition (APIS), (IP60), then, the project member reference table (ASPUT) is referred (IP61) and if the relevant member belongs to a project set to be highlighted (IP70), a symbol is plotted on a coordinate plane with the area of the symbol filled (IP71). If the member does not belong to the corresponding project, the outline of the symbol is plotted on the coordinate plane (IP75). Note that because it is the object of filling the area of a symbol to highlight only a member belonging to the corresponding project, the member may be highlighted using other method.

Moreover, as required, the name of the relevant member may be displayed so as to be adjacent to the plotted symbol.

The procedures of IP30 to IP71 are repeated until the plot for all the member plots is finished (IP80).

Moreover, finally, if the “highlight specific project” check box (PD2) is checked (IP90), an ellipse is drawn so as to enclose all the members belonging to the project, i.e., all the symbols, the areas of which have already been filled and displayed on the display, using as small ellipse as possible (IP91). Although this is done for the purpose of clarifying how the members of the project are distributed on the coordinate plane, this may not be performed, if unnecessary.

After finishing the above procedures, the flow will end (IPEN).

### <Example of Data Plot Result>

FIG. 14 shows an example of the results that are displayed (APWO) after going from the step of setting the initial condition setting (APIS) to the step of plotting data (APIP) of FIG. 3, in the first embodiment of the present invention. This example corresponds to the case where the “classify members by position” check box is checked and the “highlight specific project” check box is not checked, and the actual data obtained when 26 members each equipped with the terminal (TR) have conducted works for about two months in an actual organization is used. Hereinafter, for Embodiment 1 to Embodiment 4 of the present invention, the effects of the present invention will be verified using the actual data obtained at that time.

Note that for the symbols corresponding to the positions, a square is used for a department manager, a triangle for a section chief, and a diamond shape for a regular employee.

Moreover, in FIG. 14, the contacting number (TMNM) and the contacting time (TMTI) are daily calculated for each member, and furthermore about two months of results are averaged, respectively, and the averaged ones are taken as the coordinate value for plotting. Accordingly, in this method, the plotted display results strongly reflecting the roles assumed by the members in this period, rather than those reflecting the contents of a short-term work, may be obtained.

The result of FIG. 14 reveals that the contacting number is positively correlated with the contacting time, as a general trend. Moreover, in terms of the positions, more department managers are distributed on the upper right and more section chiefs are distributed near the center. Moreover, most of the regular employees gather on the lower left. Namely, the department managers having a role to manage an entire organization may have the increased contacting number and time because they attend various kinds of long-hour meetings, such as an administration meeting or a project reporting meeting. On the other hand, for the regular employees, it is considered that because their main work is typically an individual's task, such as literature search, data processing, document preparation, or the like, in front of a PC, and their communication is mainly performed only in discussion with co-workers or in a meeting with a section chief, i.e., direct superior, there are more members having decreased contacting number and contacting time. Moreover, since the section chiefs with a role of the leader of a project have the works of a meeting with subordinates belonging to the project, and a report to the department manager, i.e., the superior, they may be positioned near an intermediate location between the both of the department managers and the regular employees.

Accordingly, it has been found that by expressing with the approach of the present invention the results obtained using two months of data, the roles assumed by the members in an organization can be expressed from a cross section of communication.

However, the significance of the present invention is in that a person conducting communicating in a different way from an average way expected as the position can be focused rather than in that whether or not all the members follow the generally expected roles is confirmed. For example, when looking at an individual member in FIG. 14, although a person “a” and a person “b” are regular employees, they are associated with more people for longer time than most of the section chiefs. Moreover, while a person “c” is a section chief, he or she belongs to a working alone type, and has the contacting time and the contacting number that are almost an average of the regular employees. Moreover, it is also seen that there is a section chief (person “d”) who is associated with more people than any department manager. With regard to such heterogeneous members, for example, it is viewed that the person “a” and the person “b” themselves are carrying out the work beyond the frame of a regular employee, and furthermore it is thought that the person “d” perhaps has a lot of connections with various types of persons in the organization, and these persons may be hidden keys to move the organization. Moreover, the person “c” may be busy with regular employee-like actual tasks rather than communication with other people. This triggers to review, with the use of this graph, whether or not the above-described situation is a good thing as the whole organization.

### <Result for Each Project>

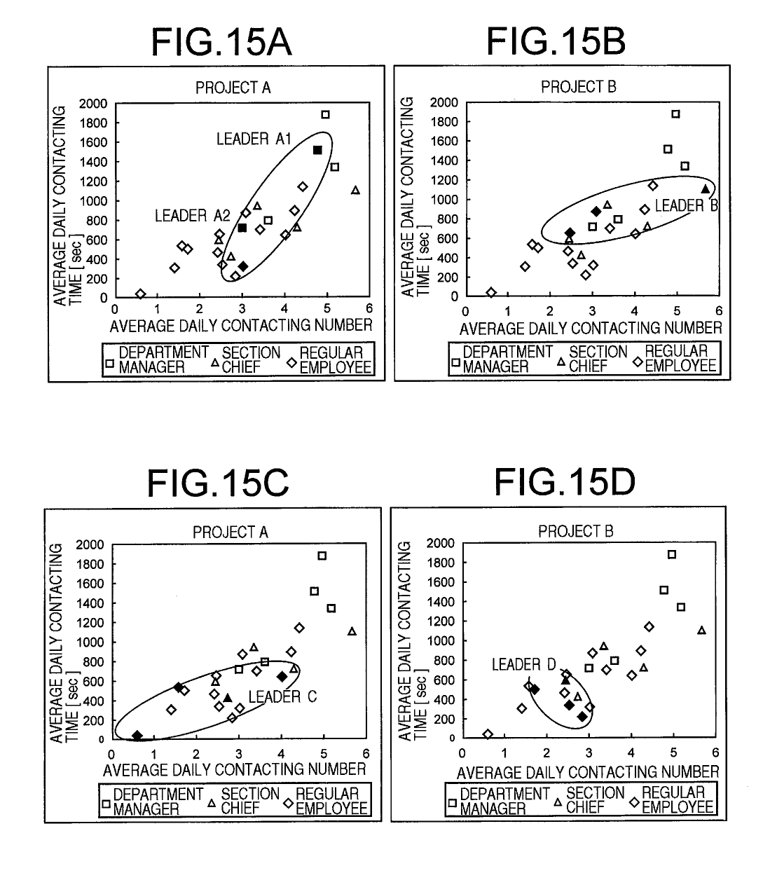

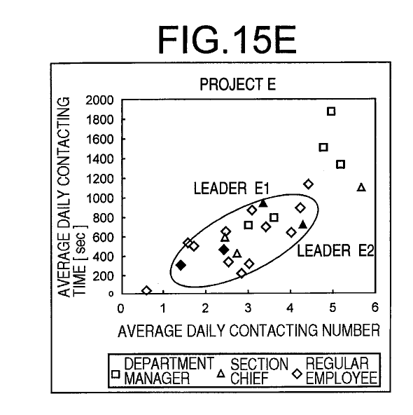

FIGS. 15A to 15E are the results obtained by checking the “highlight specific project” check box (PD2) and visualizing distributions of members in five types of projects, in the first embodiment of the present invention. A symbol plotted with the area thereof being filled indicates that the member belongs to the relevant project, and furthermore an ellipse drawn so as to enclose these members helps to indicate a deviation or a distribution in ways how to perform communication in the project.

In a project A of FIG. 15A, the ellipse is vertically elongated and exists on the right as the location. In a project B of FIG. 15B, the ellipse is horizontally elongated and exists near above the center as the location. These two are the case where one person has a totally different style in contrast to a plurality of members having the same communication style. It is found that a project C of FIG. 15C is a project, wherein the ellipse has such an oblong shape that sticks to the bottom, and wherein while the contacting numbers lie broadly, all the members have few contacting time. In a project D of FIG. 15D, the ellipse is small and round as compared with the other projects and gathers in the lower left. Namely, it is found that all the members have few communication and are associated only with closed members. In a project E of FIG. 15E, a rounded ellipse is floating near the center.

Moreover, by looking at which location in the ellipse a person corresponding to a leader in each project exists, how to proceed with each project, and the leader's standing position can be found. In most cases, a department manager expressed as a square or a section chief expressed as a triangle assumes the role of the leader. Some projects may have a plurality of leaders, wherein the assigned fields are split and each serves as the leader of each split filed.

In the project A of FIG. 15A, a leader A1 exists prominently on the upper side. It is already known that the number of meetings strongly influences the contacting time on the vertical axis because the meeting takes a long time at one time in particular. Accordingly, this leader A1 may attend a big meeting as the main member and may assume a critical role governing the project. Moreover, in the project B of FIG. 15B, a leader B who is a section chief is located prominently on the right side. Accordingly, while not attending a lot of meetings, the leaders B has a lot of connections with persons other than those belonging to the project B, and is considered to be a leader actively collecting information. In the project C of FIG. 15C, a leader is located in the center of the whole project members. A person most likely to bring a new wind into the project C is rather a regular employee located at the right end, and the leader is not such a type that individually actively takes communication outside the project. The leader C seems to be a leader responding when asked for an advice from each member but usually watching the subordinates and concentrating on supporting them. In the project D of FIG. 15D, there is a small variation as a whole, but among the members a leader D has a relatively large amount of communication (contacting time), and thus the leader D may play a role to orchestrate the members. Moreover, in the project E of FIG. 15E, since two leaders E1 and E2 have a lot of contacting time and contacting number and other two regular employees have few, it is found that the project E is a project wherein such role sharing that two leaders carry out parts, such as a meeting or a review on how to proceed with the project, requiring a lot of communication while the regular employees concentrate on their individual's tasks is clarified and proceeded with.

### <Results of Chronological Change as a Whole>

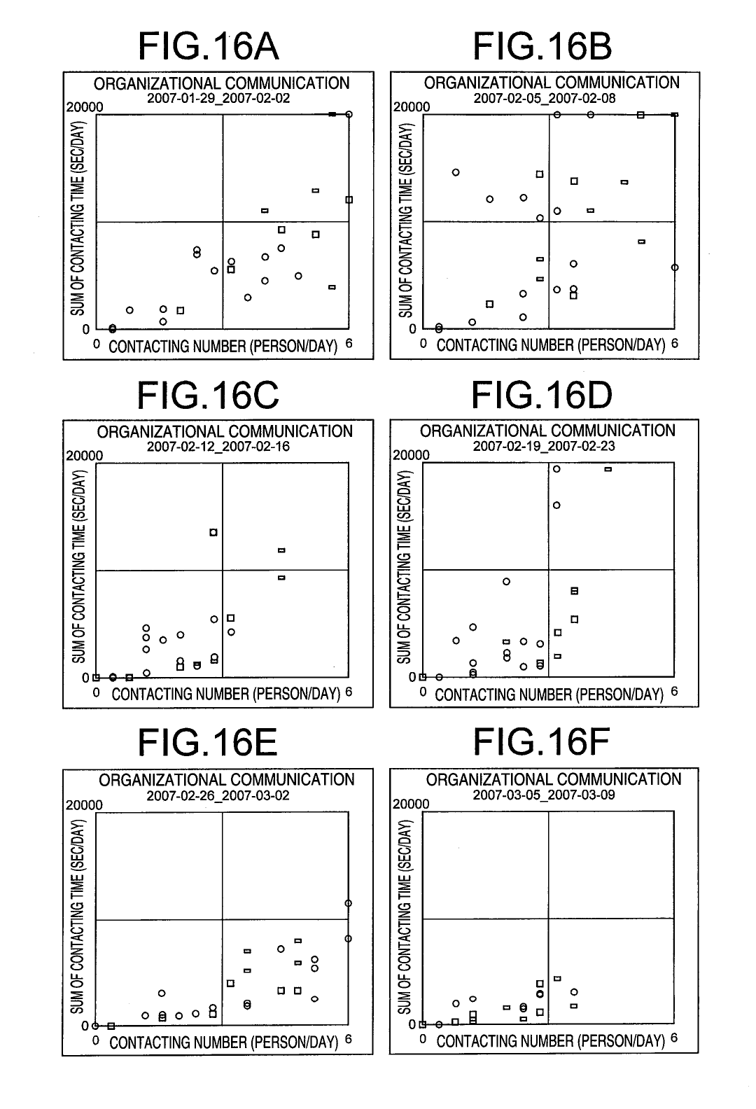

FIGS. 16A to 16F are the results obtained by weekly creating the graphs and tracking a chronological change in the organizational communication, in the first embodiment of the present invention.

In the display setting (APISPD) of the step of setting the initial condition (APIS), the “classify members by position” check box (PD1) is checked, the “highlight specific project” check box (PD2) is not checked, and consecutive six weeks are divided into each week to create one graph, respectively. In addition, a line is drawn at the respective centers of the vertical and horizontal axes to divide the area into four, which will be described later in Embodiment 2 so the description thereof is omitted here. Moreover, the correspondence between a symbol and a position differs from the correspondence in FIG. 15 and therebefore, and here an oblong rectangular represents a department manager, a square represents a section chief, and a circle represents a regular employee.

In an organization for which this data was acquired, there was an external event which a lot of members need to involve in and prepare for, in the weeks of FIG. 16C and FIG. 16E. It is found that for this reason, in the weeks (FIGS. 16B to 16D) before the respective events, the organization was activated as a whole and a lot of communications were carried out in many places. Moreover, in the weeks (FIG. 16C and FIG. 16E) of the events and in the week (FIG. 16F) after the event, a situation, in which the amount of communication decreased possibly because the members were carrying out the works postponed due to the events, is visualized by the variation of the symbols representing the respective members.

### <Chronological Change in a Certain Project>

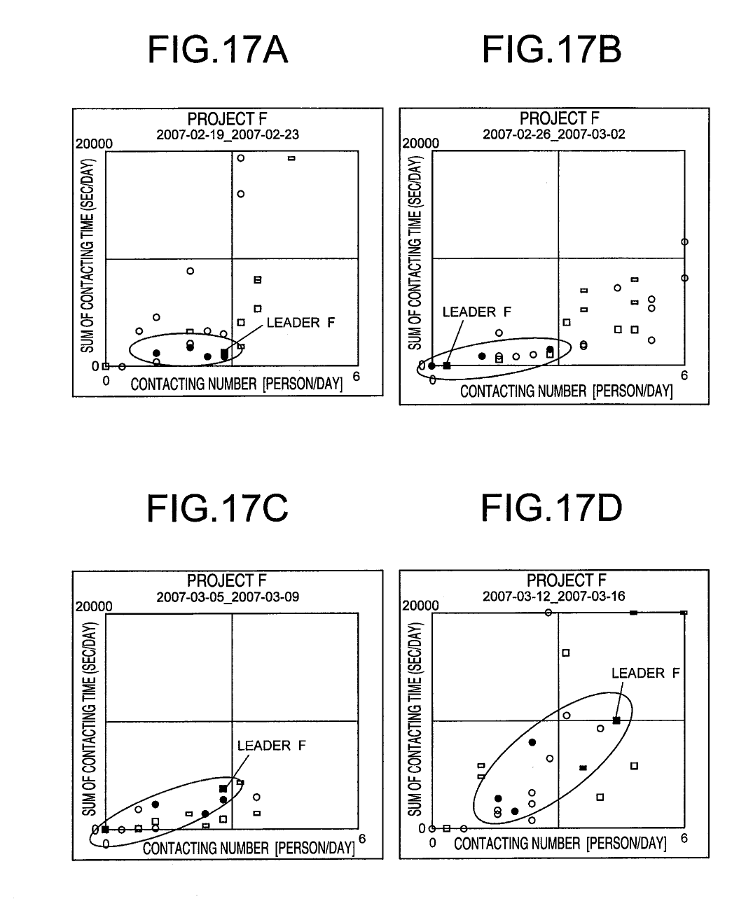

FIGS. 17A to 17D are the results obtained by weekly creating the graphs and tracking a chronological change in the organizational communication and paying attention to a certain project F, in the first embodiment of the present invention.

In the display setting (APISPD) in the step of setting the initial condition (APIS), the “classify members by position” check box (PD1) is checked, the “highlight specific project” check box (PD2) is checked, and consecutive four weeks are divided into each week to create one graph.

Among the members enclosed with an ellipse in FIGS. 17A to 17D, respectively, the one plotted with a square is a leader F of the project. At the starting point in FIG. 17, the project F was in a stage where each member takes charge of part of the work and is documenting a survey result in order to eventually present this to a customer. For this reason, in FIGS. 17A, 17B, all the project members have few communication, and gather in the lower left. In the periods of FIGS. 17A, 17B, it looks that the leader F himself or herself involved in writing documents, and concentrated on writing documents by cutting off communication with other people. However, at the beginning of the week of FIG. 17C, the situation drastically changed, and the project F had to organize the contents of the document again from scratch. Then, the situation that the ellipse is rising up as shown in FIGS. 17C, 17D reveals the situation that the members of the project F gathered to have active discussions. Moreover, it is found that at that time, the leader F was located at the upper right in the ellipse, where the leader F actively had a meeting with the department manager and discussed with the members of the project and thereby showed leadership to strongly lead the project.

<Possibility to Take Other than the Contacting Time and Number as the Axes>

Note that, in the present invention, the contacting number and time concerning each member are calculated from the data concerning the person's communication acquired using the sensor network and are taken on the horizontal and vertical axes for plotting, respectively. However, the ones obtained using other calculation method may be taken as the axes for plotting, as long as one of the axes represents a diversity in the relation with other persons and the other axis represents the amount of the relation with other persons. For example, the normalized ones obtained by dividing the contacting number and contacting time by a time period during which the sensor data could be acquired may be taken as the axes, respectively. Moreover, as the diversity of the relation with other persons, the number of persons may be counted by limiting to the contact with the persons not belonging to the same project. Alternatively, the face-to-face contacted persons, such as a person having different type of work, a person at a distant seat, a person having a different position, and a person not frequently being contacted, may be weighted and a summation of the number thereof may be set as an axis. On the other hand, as the amount of the association with other persons, the amount of time during which the members were present at the same place judging from the voices, seating information, or the like may be used.

Moreover, analysis on not only IR data but also voice data may be also added in discriminating the contact status, so that only the case where it is determined as “having conversation” can be regarded as the “face-to-face contact”.

<Possibility in the Case where a Terminal is Attached to an Article Other than a Person>

Note that communication in the present invention is a concept including also an interaction between a person and an article, not limiting to the face-to-face communication between persons.

For example, in the case where the terminal (TR) is attached to a product in a store, the occurrence of communication with a customer who has an interest in the product is grasped when the customer touches or looks into the product. By creating a display using this information, it is possible to analyze whether wide-spread customers have an interest in the product or specific type of customers have a strong interest in this product, which can be then utilized in determining where to layout the products in the store, in determining a strategy appealing to customers, or the like. Moreover, when a salesclerk explained about the relevant product to a customer, the communication among three of the salesclerk, customer, and product can be detected through the terminal (TR). This information can be helpful in verifying an effect to the revenue caused by a salesclerk speaking to a customer. Moreover, by combining the acceleration and voice data acquired by the respective terminals (TR), it is possible to analyze the effective timing when a salesclerk speaks to a customer, or an effective gesture or tone of voice at the time of explanation.

Moreover, in the case where the terminal (TR) is attached to the devices, such as a PC or a copy machine in an office, or an electric coffee percolator, by creating a display using the information of the terminal (TR), it is possible to classify a device which various types of persons each use a little, a device which only specific persons use, a device which a lot of persons use for a long time, and the like. Moreover, according to the information of the terminal (TR) and persons, who uses the device in what kind of time zone can be recognized. This makes it possible to capture each member's working style more broadly. Moreover, by detecting the fact that making a copy or making a coffee triggers to have conversation with various types of people, it is possible to utilize the graphs in an office design for further activating communications.

Moreover, in the case where the terminal (TR) is attached, in a room or an area, such as a meeting room, a vending machine area, a smoking area, the entrance or wall surface thereof, the center of a table, or the like, a display is created using the information of this terminal (TR), thereby allowing to classify a place where various types of persons come in and come out by turns, and a place where only specific persons are present, a place where a lot of people stay for a long time. Moreover, through the information of the terminal (TR) in a room or an area, or on a person, what kind of persons gather in the relevant room or area in which time zone, at which place the communication becomes active, or what kind of place is effective for creating an idea, can be analyzed to utilize this result in office design.

### Embodiment 2

A second embodiment of the present invention is described with reference to the accompanying drawings.

### Overview of Embodiment 2

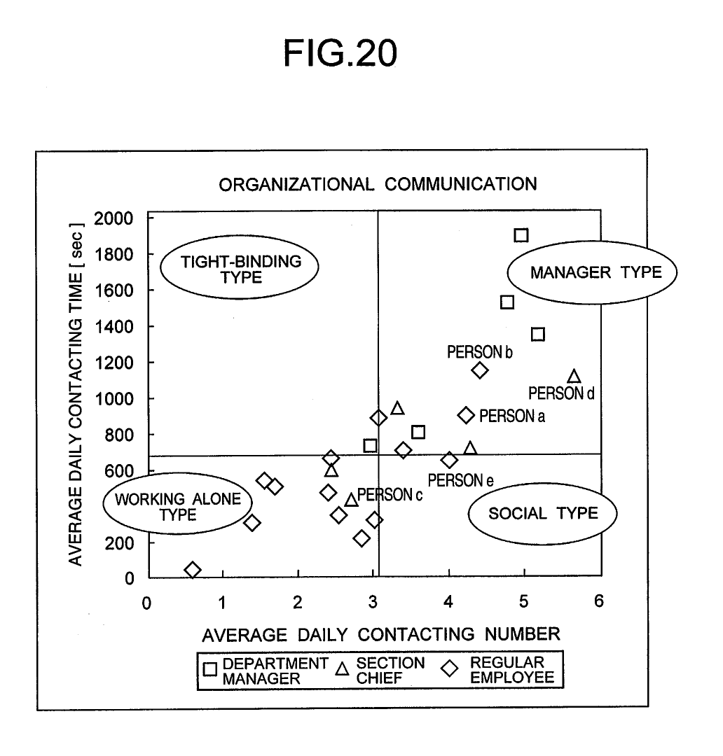

In Embodiment 2, the expression based on the method of Embodiment 1 is divided into four areas, and a name is given to each area for classification. While the terms, such as “upper right” and “lower”, were used in describing the results of Embodiment 1, this classification makes the communication style of each member intuitively clearer. Specifically, a graph as shown in FIG. 20 is created.

### <Description of Four Classifications>

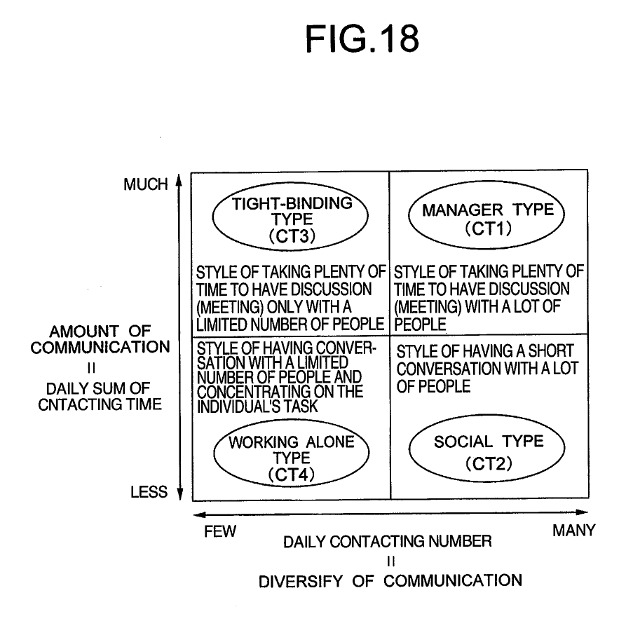

FIG. 18 is a view for explaining the meaning which each area has, in the second embodiment of the present invention.

A person to be plotted in the upper right, where the contacting number is large and the contacting time is long, is often plotted in this position as a result of having a long time meeting with a lot of people. Since the results of Embodiment 1 revealed that within this area there are more managers in particular, an area (CT1) is named as a “manager type”.

Moreover, a person to be plotted in the lower right, where the contacting number is large but the contacting time is not long, may be a sociable person performing a greeting and small chat with a lot of people. Accordingly, an area (CT2) is named as a “social type”.

Moreover, a person to be plotted in the upper left, where the contacting number is small but the contacting time is long, may take plenty of time to have a meeting and discussion with a limited number of specific persons (direct superior, subordinates, members of the same project, or the like) having a deep relation in the course of their works. Accordingly, an area (CT3) is named as a “tight-binding type”.

Moreover, a person to be plotted in the lower right area, where the contacting number is small and the contacting time is also short, is just having a short conversation with a limited number of persons, and thus this person may have few communication and concentrate on the individual's task. Accordingly, an area (CT4) is named a “working alone type”.

In this case, the visualization system for organizational communication of the present invention divides a coordinate plane into four areas, wherein among these four areas, a first area, in which a feature quantity indicative of an intensity is large and a feature quantity indicative of a diversity is large, is defined as a manager type area, a second area, in which the feature quantity indicative of the intensity is small and the feature quantity indicative of the diversity is large, is defined as a social type area, a third area, in which the feature quantity indicative of the intensity is large and the feature quantity indicative of the diversity is small, is defined as a tight-binding type area, and a fourth area, in which the feature quantity indicative of the intensity is small and the feature quantity indicative of the diversity is small, is defined as a working alone type area, and wherein a person belonging to each area of the four areas is displayed so as to be recognized separately from each other, thereby visualizing a type of communication of a relevant organization.

For the above-described name for each area, any name except those enumerated above may be given. However, the name shall represent the characteristic feature of the relevant area appropriately.

### <Flowchart of Plot>

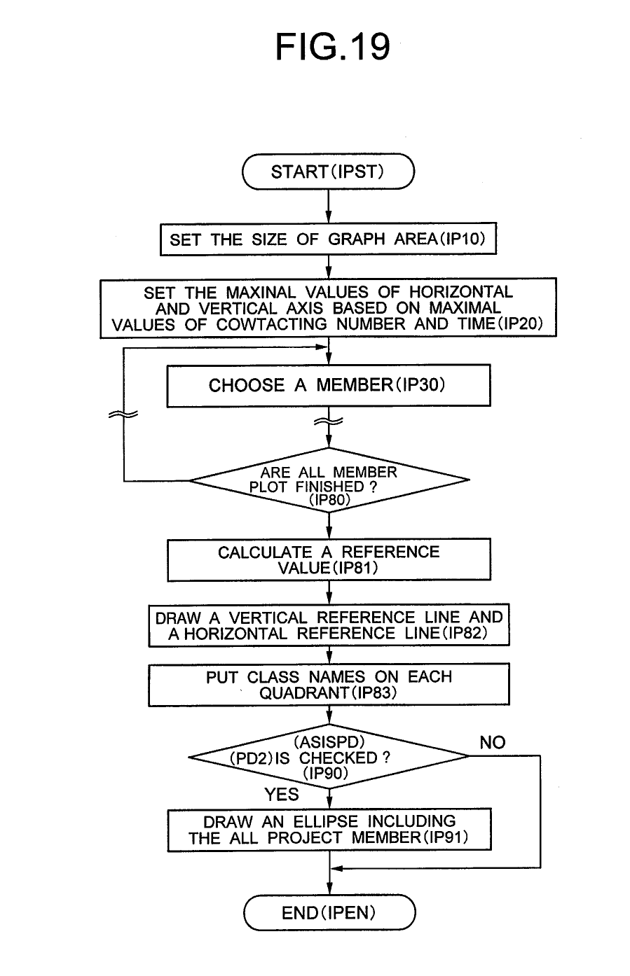

FIG. 19 is a flowchart showing the details of the step of plotting data (APIP) in the overall flowchart of FIG. 3, in the second embodiment of the present invention. Since the procedures other than the step of plotting data (APIP) of FIG. 3 are almost the same as those in Embodiment 1, the description thereof is omitted.

Moreover, in FIG. 19, only portions, in which new processes are introduced between the steps of “Are all the member plot are finished?” (IP80) and “Is PDW in ASIPSD checked?” (IP90) in FIG. 13, are new and all the others are the same as those of FIG. 13.

The procedures newly introduced in Embodiment 2 are a step of calculating two reference values serving as the boundaries in dividing the area into four (IP81), a step of drawing, based on these values, two reference lines (serving as the border lines between the respective areas) (IP82), and a step of putting a class name onto each area (IP83). The last step may be omitted if the class name does not need to be put on the graph.

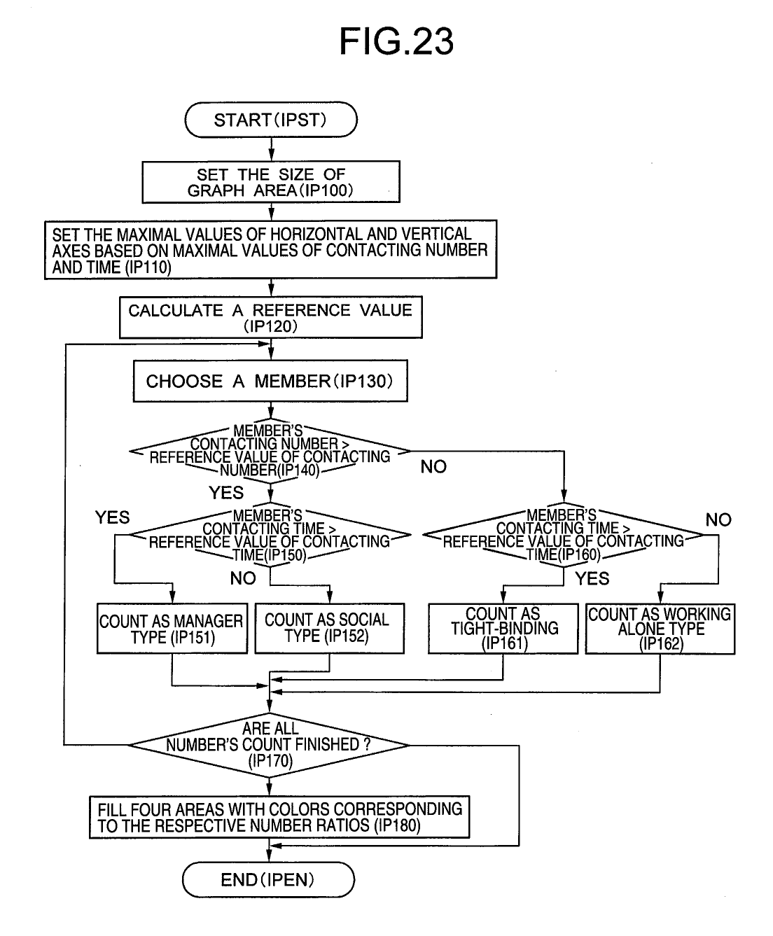

In the step of calculating the reference values (IP81), the respective medians of the contacting number and the contacting time for all the members to be plotted on the graph are calculated and the resultant values are set to the reference values. Alternatively, half the maximal values on the horizontal axis and vertical axis determined in IP20 may be used as the reference values. In the case where the former is used, the members will be classified equally on the left and right sides of the reference line. The members will be classified equally on the upper and lower sides of the reference line, as well. When the latter is used, the graph is easy to view since the reference lines always come to the center of the graph. The lines of FIG. 16 and FIG. 17 are drawn with half the values of the axes as the reference values. In FIG. 23 and thereafter, the lines are drawn with the medians as the reference values.

Next, the vertical reference line is drawn at the location of the reference value of the contacting number, and the horizontal line is drawn at the location of the reference value of the contacting time (IP82). Then, the class names are put in the four determined areas (IP83).

In the case where the median of all the plot data is used as the reference value, since the coordinate values to be plotted for all the members plot need to have already been calculated, IP81 to IP83 are arranged after finishing plot (IP80), while in the case where the reference values are determined in advance, these procedures may be implemented after setting the maximal values of the horizontal axis and the vertical axis (IP20).

### Result of Embodiment 2

FIG. 20 is an example of a created graph in the second embodiment of the present invention. The plotted data is the same as that of FIG. 14. By clarifying the respective areas, it is possible to easily describe using the class names, for example, that the person “a” is carrying out the manager type communication, or the person “c” is carrying out the working alone type communication although he or she is a section chief.

### Results (Project-Based) of Embodiment 2

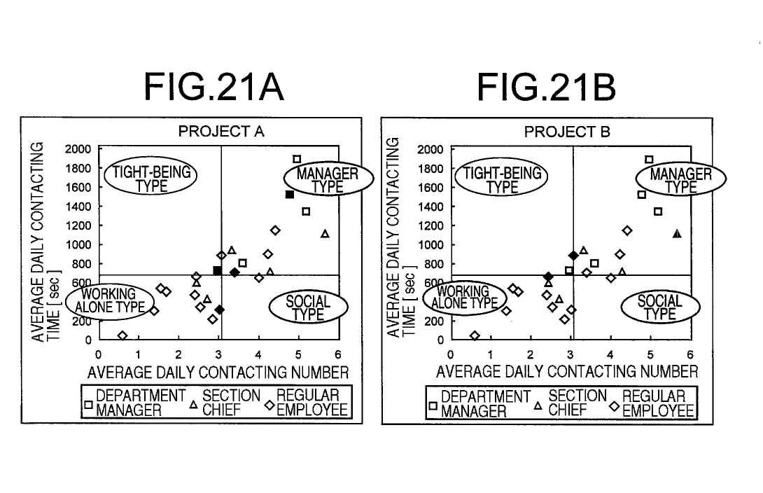

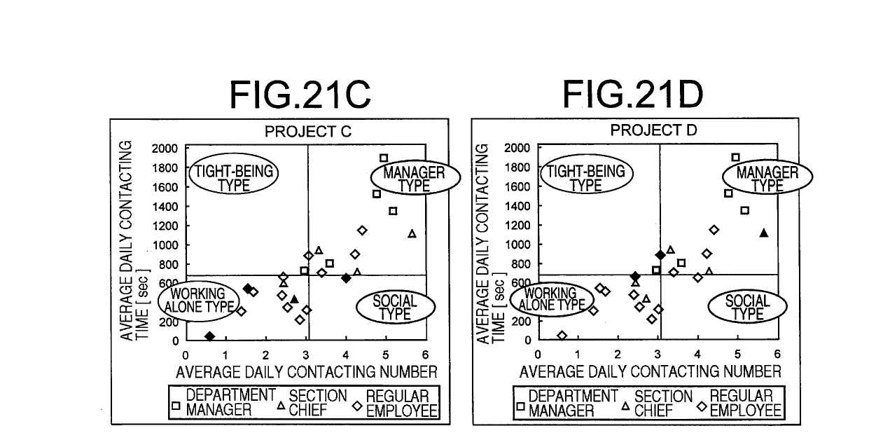

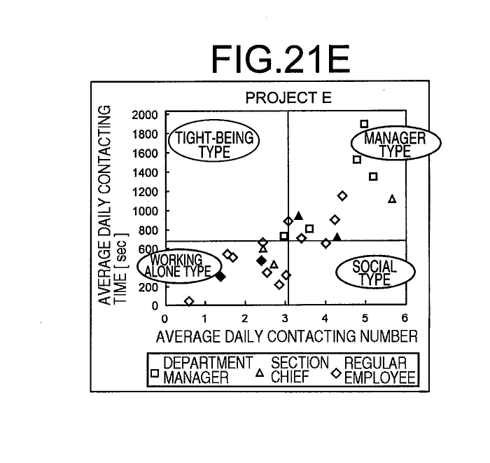

FIG. 21 illustrates the results obtained by checking the “highlight specific project” check box (PD2) and visualizing distributions of the members in five types of projects, in the second embodiment of the present invention. The plotted data is the same as that of FIG. 15 and differs from FIG. 15 in that the area is divided.

In the project A of FIG. 21A, among four persons, two persons are of the manager type, one person is of the tight-binding type, one person is of the working alone type, but all the members are located in the right area from the center. It is found that this is a project having relation with a lot of people although there is a variation in the contacting time.

In the project B of FIG. 21B, among three persons, two person are of the manager type and one person is of the working alone type, but all the members are located in an area from the center to thereabove. This indicates that the project B is a project having a lot of communication and having an argumentative nature.

In the project C of FIG. 21C, among four persons, one person is of the social type, three persons are of the working alone type, and all the members are located in an area from the center to therebelow.

In the project D of FIG. 21D, all the members of four are of the working alone type. Since all the members have a similar communication style, the relation is closed within the project and there are few contacts with external members, and accordingly, a new wind for a change may not comes in.

In the project E of FIG. 21E, among four persons, two persons are of the manager type, and two persons are of the working alone type. As in the findings in FIG. 15, this classification reveals the peculiar nature of the project E.

In FIG. 15, the results can be analyzed from the view points of a distribution and variation in the members and the location of the leader, while in FIG. 21, the data is daringly digitized and classified into four types, thereby enabling the analysis from a viewpoint of clarifying the cross section, such as paying attention to the common point and variation only on the horizontal axis, or paying attention to the common point and variation only on the vertical axis.

### Embodiment 3

A third embodiment of the present invention is described with reference to the accompanying drawings.

### Overview of Embodiment 3

In FIG. 21 of Embodiment 2, the reference lines classifying the area is added to the plotted graph, thereby indicating the communication style of each project, i.e., from what types of communication style members a project is constituted.

Embodiment 3 specializes in further simplifying Embodiment 2 and expressing the membership of a project.

### <Quadrants of a Project>

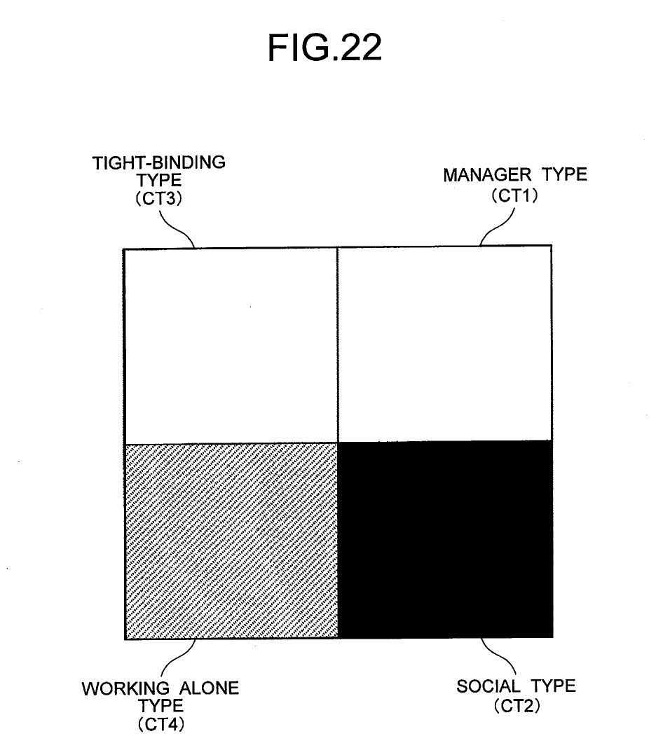

FIG. 22 is an example of a graph created in the third embodiment of the present invention. In FIG. 21 of Embodiment 2, how many members of each project are included in the respective four areas is counted, while in FIG. 22, the individual plot is omitted, and an area where a lot of members are distributed is expressed with a darker color, thereby indicating the deviation in the members in a project.

In this case, the above-described correlated display is a display, wherein a coordinate plane consisting of two axes, in which a feature quantity indicative of an intensity is assigned to one axis and a feature quantity indicative of a diversity is assigned to other axis, is divided into four areas, wherein among the four areas, a first area, in which the feature quantity indicative of the intensity is large and the feature quantity indicative of the diversity is large, is defined as the manager type area, a second area, in which the feature quantity indicative of the intensity is small and the feature quantity indicative of the diversity is large, is defined as the social type area, a third area, in which the feature quantity indicative of the intensity is large and the feature quantity indicative of the diversity is small, is defined as the tight-binding type area, and a fourth area, in which the feature quantity indicative of the intensity is small and the feature quantity indicative of the diversity is small, is defined as the working alone type area, and wherein a color tone corresponding to the number of persons belonging to each area of the four areas is arranged to each area.

In a project consisting of three persons of the social type (CT2) and one person of the working alone type (CT4), the area (CT2) is expressed by a dark color, the area (CT4) by a light color, and the remaining areas (CT1, CT3) by white, as shown in FIG. 22. Accordingly, the way how to communicate in this project can be interpreted as characterized in that the diversity (contacting number) is large but the amount (contacting time) is small.

### <Flowchart of Plot>

FIG. 23 is a flowchart showing the details of the steps of plotting data (APIP) in the overall flowchart of FIG. 3, in the third embodiment of the present invention. Since the procedures other than the step of plotting data (APIP) of FIG. 3 are almost the same as those in Embodiment 1, the description thereof is omitted.

After starting to plot data (IPST), the size of a graph area is determined first (IP100), and the maximal values of the contacting number and time are calculated (IP110), and then the reference values are calculated (IP120), but these are the same processes as the process (IP10), the process (IP20), and the process (IP81) in FIG. 19 of Embodiment 2, respectively.

Next, it is determined which area each member is to be classified into, and the number of persons for each area is counted. One member is chosen (IP130), and then it is determined whether or not the contacting number of this member is larger than a reference value (IP140) and furthermore, it is determined whether or not the contacting time of the member is larger than a reference value (IP150, IP160). If the both are larger, the member is counted as the manager type (IP150); if the contacting number is larger and the contacting time is shorter, the member is counted as the social type (IP152); if the contacting number is smaller and the contacting time is longer, the member is counted as the tight-binding type (IP161); and if the both are smaller, the member is counted as the working alone type (IP162). Note that the order of the discrimination of the contacting number and time relative to the reference values may be reversed. These steps will be repeated until the counting for all the members is finished (IP170).

Finally, these four areas are distinguishably filled with colors corresponding to the respective number ratios (IP180), and then the flow will end (IPEN). For the color, only the depth of one color may be varied depending on the number ratios, or the different colors may be set.

### <Result for Each Project>

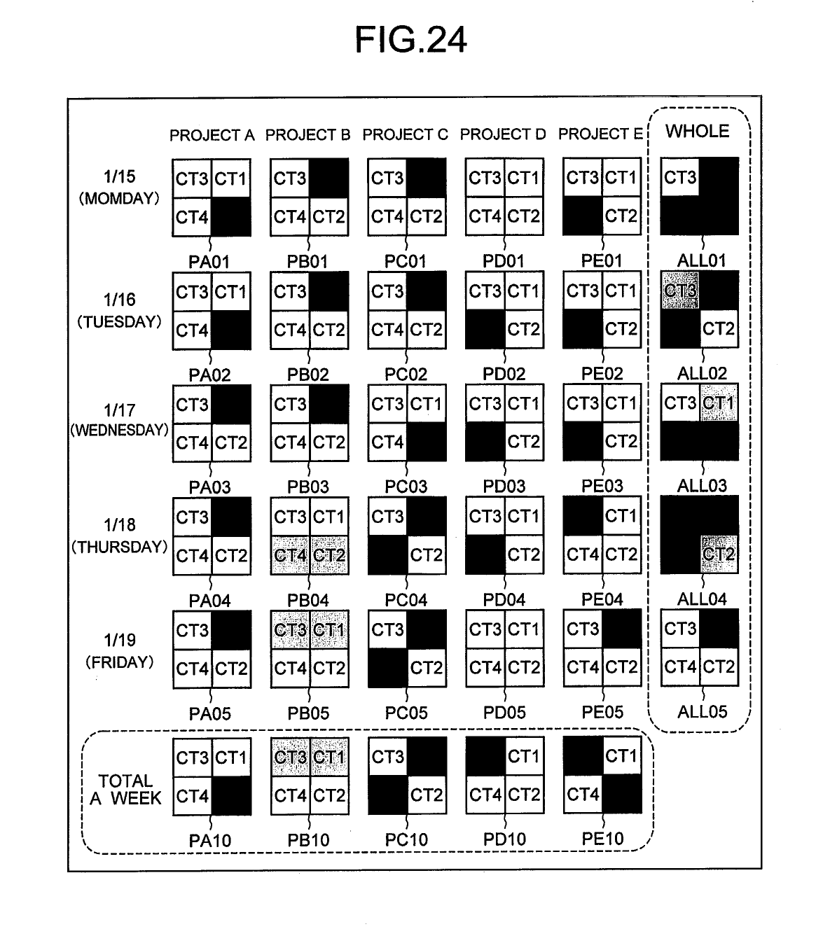

FIG. 24 shows the results (PA01 to PA05, PB01 to PB05, PC01 to PC05, PD01 to PD05, PE01 to PE05) obtained by daily creating a diagram for each project, in the third embodiment of the present invention. Moreover, the results (PA10, PB10, PC10, PD10, PE10) in one-week total of each project are put at the bottom, and the daily results as the entire organization (ALL01 to ALL05) are put at the right end.

In this way, the correlated display may be performed in a similar manner at a plurality of time points, whereby along a time sequence including the plurality of time points, the coordinate plane at the plurality of time points can be one-dimensionally arranged and displayed.

Alternatively, the correlated display may be performed in a similar manner to a plurality of organizations, whereby the plurality of coordinate planes corresponding to the plurality of organizations can be one-dimensionally arranged and displayed, and furthermore, the correlated display may be further performed in a similar manner at the plurality of time points, whereby along a time sequence including the plurality of time points, one-dimensional arrangement of the plurality of coordinate planes corresponding to the plurality of organizations at each time point of the plurality of time points may be further arranged one-dimensionally, thereby two-dimensionally displaying the whole thereof.

Here, the daily contacting number and time for all the members are calculated altogether for 5 days, and then the median values of the contacting number and the contacting time among as many pieces of data as (number of days)×(number of persons) are used as the common reference values. This permits the project-by-project comparison and the analysis on a daily variation. In the case of the one-week total, the values for five days were summed to calculate the contacting number and contacting time, and the median value among as many pieces of data as the number of persons was used as the reference value. Accordingly, a sum of the number of persons from Monday through Friday is not necessarily reflected on the one-week total.

In the project-based daily data (PA01 to PA05, PB01 to PB05, PC01 to PC05, PD01 to PD05, PE01 to PE05), a change in how each project is operated on the respective days can be tracked. For example, in the project B, it is found that all the members had a lot of meetings and were actively communicating from Monday through Wednesday (PB01 to PB03) but the amount of communication decreased on Thursday (PB04).

Moreover, the data calculated through one week for each project (PA10, PB10, PC10, PD10, PE10) may reflect the nature of the work of a project or the characters of the members. For example, the project B (PA01) can be interpreted as having a lot of communications and being argumentative or the project D (PD10) can be interpreted as having only tight-binding type members and being exclusive.

Furthermore, in the daily results as the entire organization (ALL01 to ALL05), it can be found that the mood on the relevant day, i.e., whether or not the communication was active as a whole. For example, it is found that on Friday (ALL05) the organization seems biased to the manager type and a lot of members actively performed a lot of communications, while on Wednesday (ALL03), the center of gravity lies in the lower part with few communications, and it was a quiet day.

### Embodiment 4

A fourth embodiment of the present invention is described with reference to the accompanying drawings.

### Overview of Embodiment 4

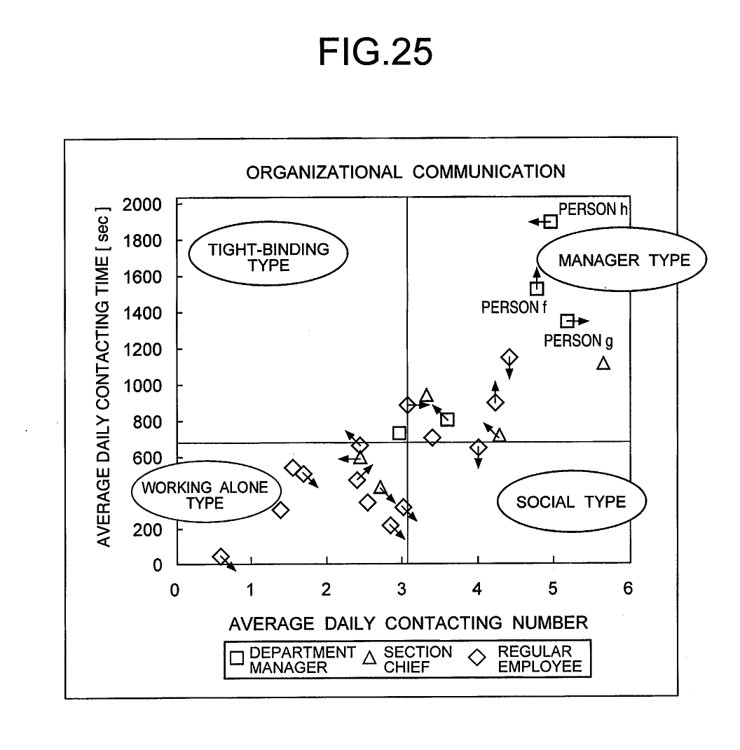

In Embodiment 4, in addition to the expression of Embodiment 1 or Embodiment 2, an inclination of the individual's communication judged from subjective performance evaluation is expressed with an arrow (vector). FIG. 25 shows an example of the results of a display created in Embodiment 4. Note that FIG. 25 is based on the expression of Embodiment 2.

Specifically, this visualization system for organizational communication is characterized in that in addition to the plotted symbols, an arrow indicative of an inclination concerning the communication of a person corresponding to the relevant symbol is displayed corresponding to this symbol.

### <Description of a Method for Expressing the Inclination of Communication>

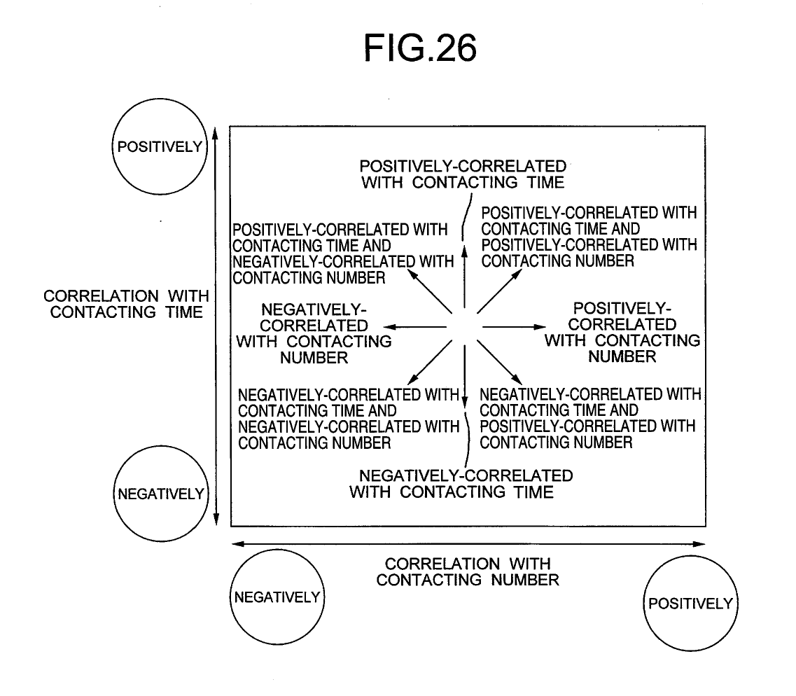

The individual arrow of FIG. 25 indicates a positive or negative correlation coefficient between the contacting time and contacting number and the performance evaluation concerning each member. This expresses, with the direction of an arrow, what type of communication would improve or decrease the relevant member's performance. Note that if the absolute value of the correlation coefficient is no more than a certain value, it is treated as “no correlation” and an arrow shall not be displayed. FIG. 26 shows a relation between the directions of the arrow and the positive/negative correlation coefficients with respect to the contacting time and contacting number. When positively-correlated with the contacting time, namely, for a member who would improve his/her performance with more communications, the direction of the arrow is expressed upward. In contrast, when negatively-correlated with the contacting time, namely, for a member who would improve his/her performance with less communications, the direction of the arrow is expressed downward. Moreover, when positively-correlated with the contacting number, namely, for a member who would improve his/her performance with association with more people, the direction of the arrow is expressed rightward, and when negatively-correlated with the contacting number, namely, for a member who would improve his/her performance with association with fewer people, the direction of the arrow is expressed leftward. Furthermore, when positively-correlated with both the contacting time and the contacting number, or when negatively-correlated with the both, or when positively-correlated with one of them and negatively-correlated with the other, the respective cases can be thought as a sum of the upward, downward, leftward, and rightward vectors, and are expressed as diagonal arrows, as shown in FIG. 26. Note that with regard to the arrow (vector), only the direction thereof shall be considered and the length thereof is fixed.

FIG. 25 shows the results of the calculation of the correlations for all the members, with an arrow added thereto. When paying attention to each member, the individual's character and the inclination in communications, such as a policy in how to proceed with the work, can be expressed. Moreover, when looking down this as a whole as in a bird's view, the pattern of the communication currently performed, namely, what kind of tendency is present between the four classes of communications described in Embodiment 2 and the desired inclination of communication can be captured from this diagram.

### Result and Effect of Embodiment 4

Effects obtained by applying Embodiment 4 to the organization management are specifically described using the results of FIG. 25.

First, in FIG. 25, paying attention to the working alone type area, there are many members with a vector pointing to the lower right. Namely, members of the working alone type feel that talking with a lot of people is an advantage but being tied up for a long time is a disadvantage. In particular, based on the fact that the breakdown of the members includes a lot of regular employees, they may have a desire to increase their ability by intensively tackling with their own work rather than by having a meeting or discussion for a long hour.

In contrast, three department managers: a person “f”; a person “g”; and a person “h” of the manager type, in the upper right are negatively-correlated with the contacting number, positively-correlated with the contacting time, and positively-correlated with the contacting number, respectively. A concern on the person “h” is that he or she feels that the present contacting number is too many to himself or herself since fewer people to be associated with would increase the degree of satisfaction. While the person “g” also has relatively many contacting numbers at present, nevertheless, association with more people would increase the degree of satisfaction in work, in contrast to the person “h”. Moreover, for the person “f”, although non-correlated with the contacting number, longer contacting time would increase the degree of satisfaction. The members whose communication type belongs to the manager type may be already in a position to often make decisions through a management meeting or discussion with subordinates. Accordingly, the person “f” and person “g” may feel that communication with a lot of people or for a long time is the achievement in their work.

Accordingly, it is found that the members whose communication type belongs to the working alone type consider the individual's work, such as survey and analysis, as an important work, and the members whose communication type belongs to the manager types consider a meeting as an important work. For such members, their “status-quo” and “inclination” of a way how to perform communication can be viewed as matching with each other. However, in a pattern, wherein the “status-quo” and the “inclination” do not match with each other, such as the case where a person desires to reduce the amount of communications as the “inclination” while performing the manager type communication as the “status-quo”, the style of the relevant person and the nature of the assigned work may not match with each other, thereby causing a stress. By paying attention to such members and reviewing the organization formation and the assignment of work while following these members, it is possible to utilize the above results in forming a more active organization.

### <Configuration Diagram of Whole System>

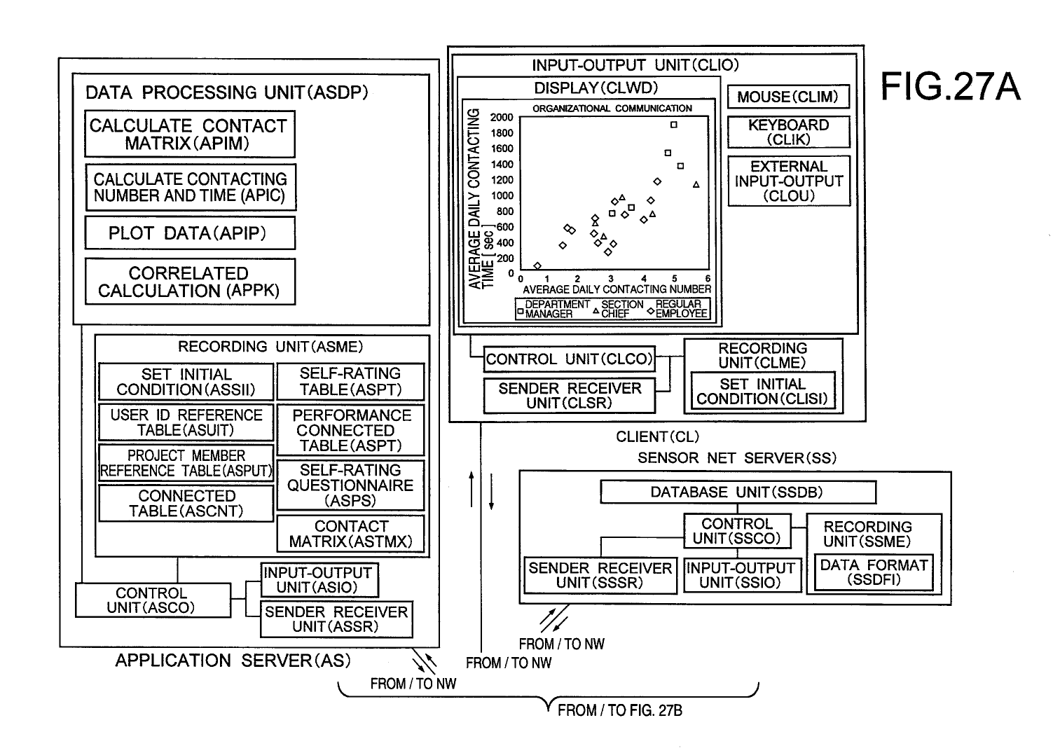

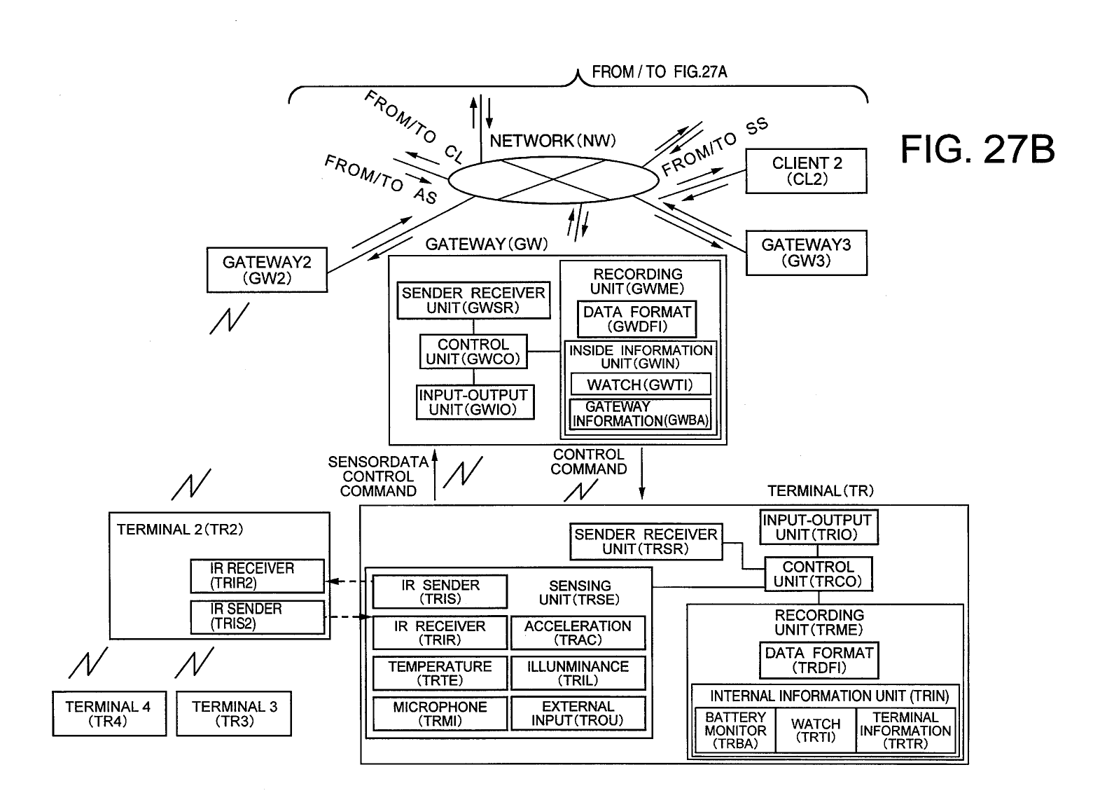

FIG. 27 is an explanatory view of the configuration of a whole system including from a terminal for acquiring interaction data to an application for displaying the obtained data, in a fourth embodiment of the present invention.

FIG. 27 differs from FIG. 1 of Embodiment 1 only in that a correlated calculation (APPK) is added in the data processing unit (ASDP) in the application server (AS) and that a self-rating table (ASPT), a performance connected table (ASPC), and a self-rating questionnaire (ASPS) are added in the recording unit (ASME).

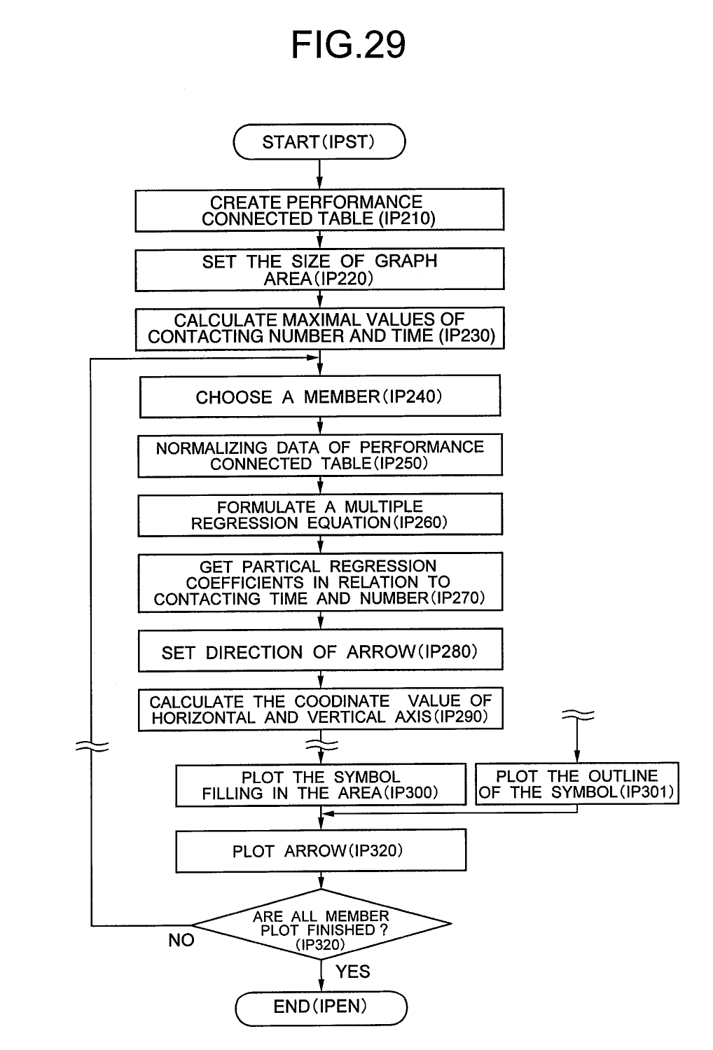

The correlated calculation (APPK) is a process to calculate a correlation between the performance data and the sensor data. The details of the calculation process and plot process are combined and shown in FIG. 29.

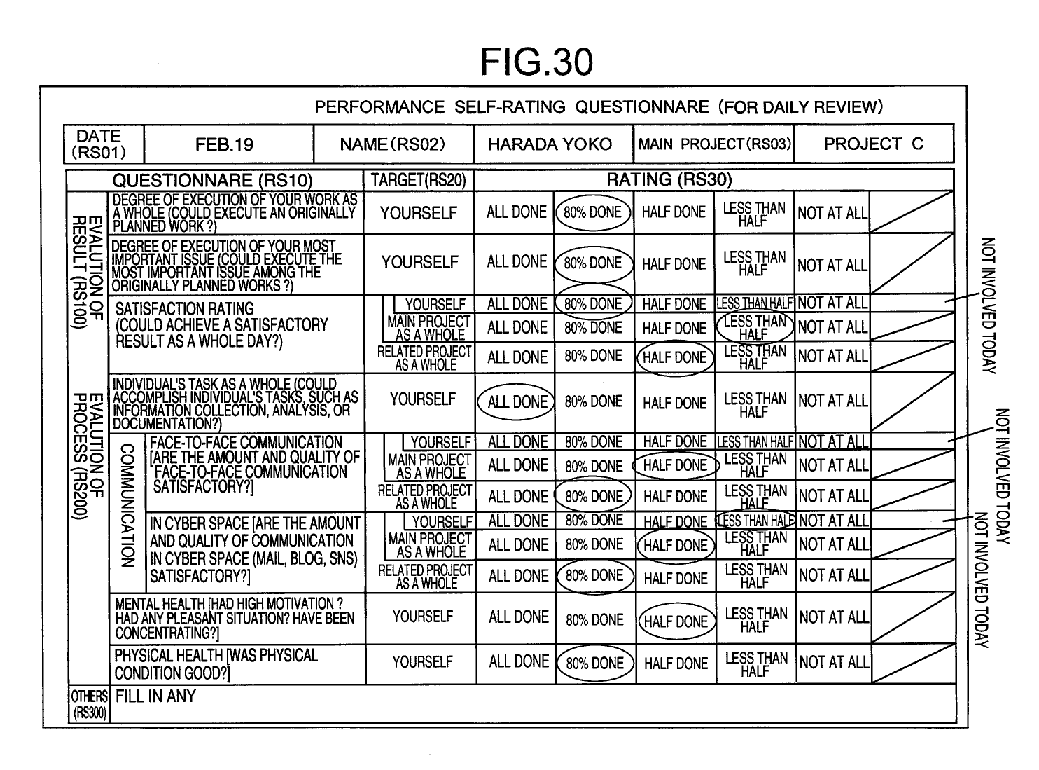

The self-rating table (ASPT) is a table, on which an individual's self-rating result shown in FIG. 30 is summarized.

The self-rating questionnaire (ASPS) is presented to the user (US) so as to cause the user to input the rated performance. An example is shown in FIG. 30. The self-rating questionnaire (ASPS) may be stored on the application server (AS) in advance, so that only when there is a request from the user (US), it may be sent to the client (CL) and displayed on a screen, or it may be stored in the client (CL) from the beginning. Moreover, the self-rating questionnaire (ASPS) may be printed in advance so that the user (US) may have this at his/her disposal in the form of paper.

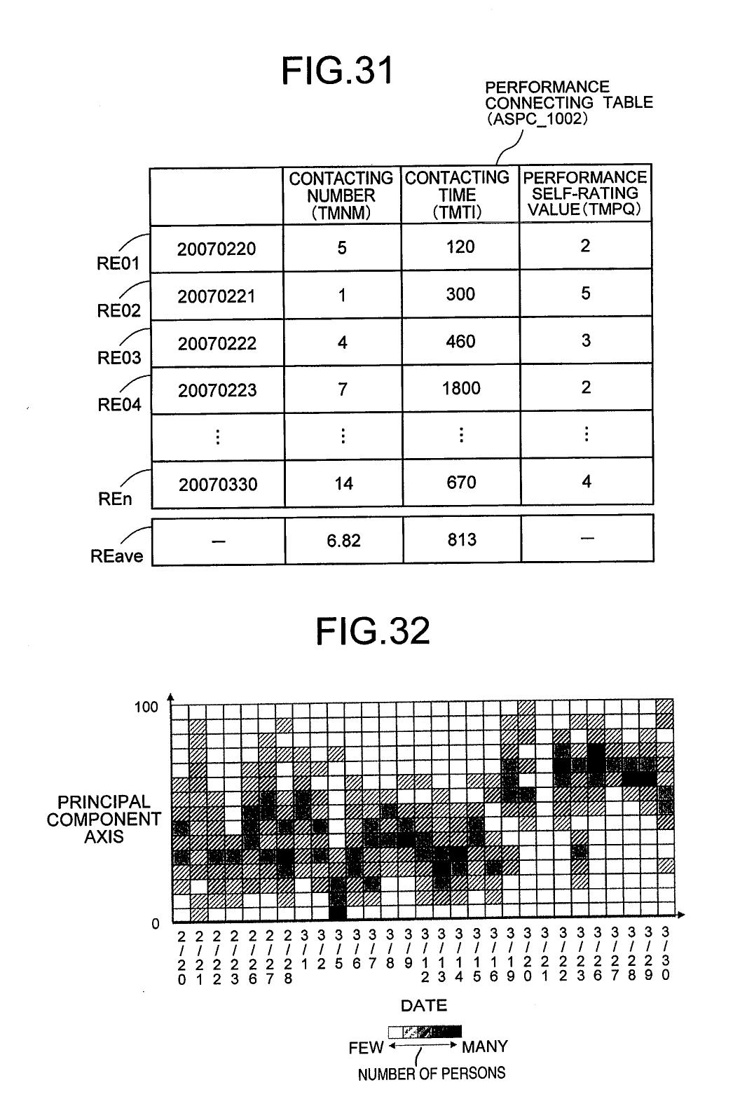

The performance connected table (ASPC) is a table, in which the sensor data and performance data of the same person on the same date are associated with each other, and this example is shown in FIG. 31.

### <Sequence Diagram>

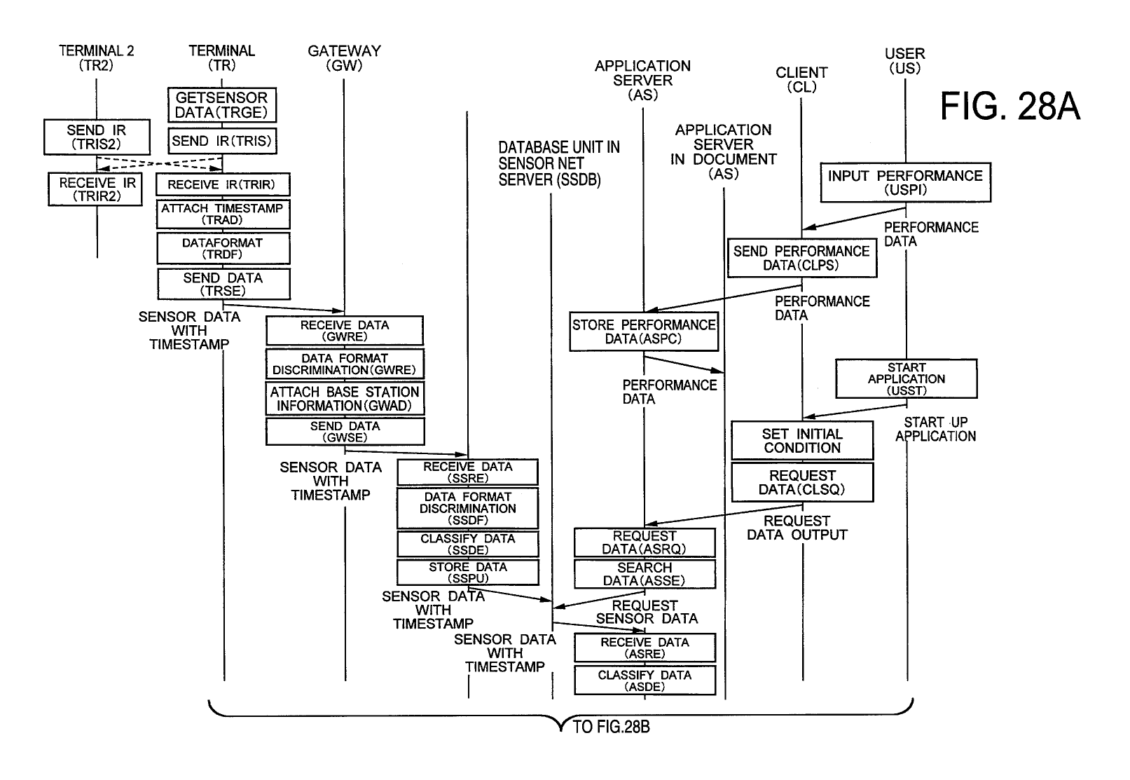

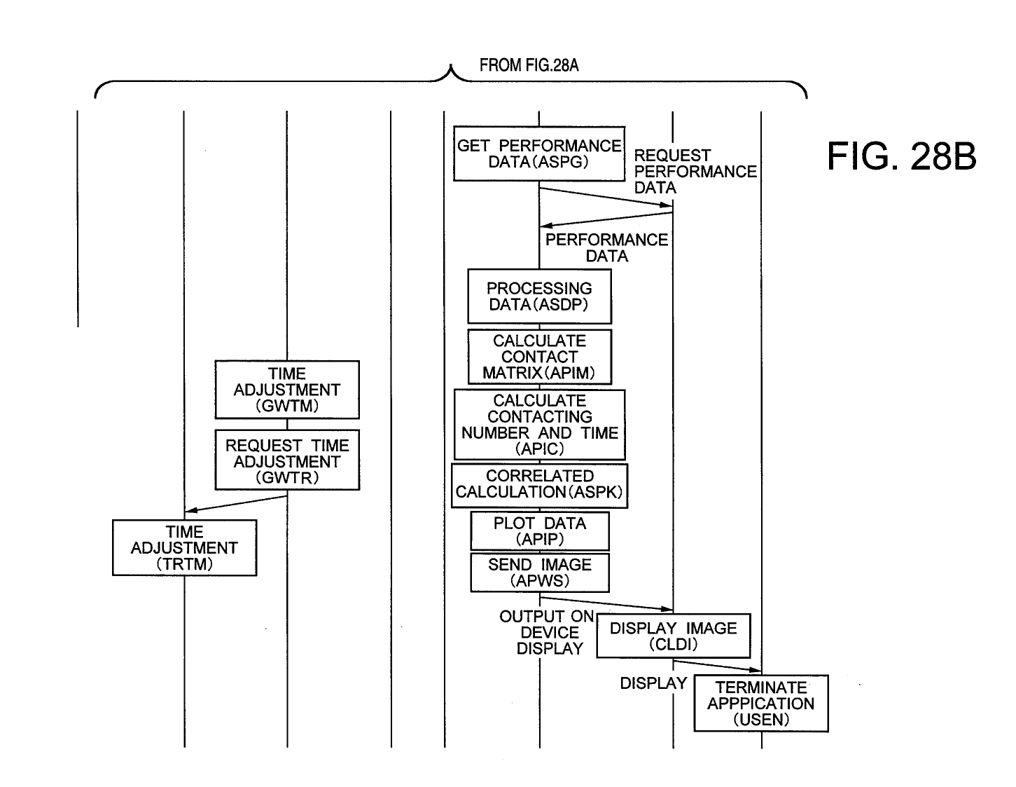

FIG. 28 is a sequence diagram showing a process flow in the fourth embodiment of the present invention.

FIG. 28 differs from FIG. 2 only in the portions involved in the inputting, storing, and processing of the performance data. Specifically speaking, these are the following five steps of inputting performance (USPI), sending performance data (CLPS), storing performance data (ASPC), get performance data (ASPG), and calculating performance (ASPK).

In the step of inputting performance (USPI), for example, once a day or the like, the user (US) looks back on his/her work to rate the performance and input this result into the self-rating questionnaire (ASPS). The inputted result is sent to the application server (AS) through the client (CL), (CLPS), and is recorded and stored on the self-rating table (ASPT) of the recording unit (ASME) in the application server (AS), (ASPC).

Moreover, the performance data is used in creating the graph of FIG. 25 after starting the application. In getting sensor data from the database as the step of getting data (APDG) in the whole process flow of FIG. 3, the performance data of the required member and date-time are acquired from the self-rating table (ASPT), (ASPG). Furthermore, as in Embodiment 1, the performance correlated calculation (ASPK) is performed after counting the contacting number and time (APIC). The subsequent procedure of the data plot (APIP) is shown in FIG. 29.

### <Flowchart>

FIG. 29 is a flowchart showing together the details of the step of plotting data (APIP) in the overall flowchart of FIG. 3 and the newly-added step of performance correlated calculation (APPK), in the fourth embodiment of the present invention. Since the procedures other than the step of plotting data (APIP) of FIG. 3 are almost the same as those in Embodiment 1, the description thereof is omitted.

In the step of plotting data (APIP) in Embodiment 4, the procedures of the correlation calculation or multiple regression analysis between the sensor data (contacting time and contacting number) and the performance rated value, and the step of plotting an arrow are added to the step of plotting data (APIP) of Embodiment 1 or Embodiment 2.

In the performance correlated calculation (ASPK), a correlation coefficient when an explanatory variable is set to the contacting number and a criterion variable is set to the performance rated value is calculated, and further a correlation coefficient when the explanatory variable is set to the contacting time and the criterion variable is set to the performance rated value is calculated. Alternatively, with the explanatory variables being set to the contacting number and the contacting time, and the criterion variable being set to the performance rated value, the multiple regression analysis is performed to calculate the partial regression coefficient.

Either method may be employed provided that whether the contacting number and the contacting time, respectively, have a positive influence or have negative influence on the performance rated value can be determined from the correlation coefficient or the partial regression coefficient. The flowchart of FIG. 29 presents a method of using the partial regression coefficient calculated by using the multiple regression analysis.

First, after starting to plot data (IPST), the performance connected table (ASPC) is created for each member. An example of the performance connected table (ASPC) is shown in FIG. 31. Assume this is a performance connected table (ASPC 1002) concerning the user (US) with the terminal ID of 1002. Here, as the feature quantity calculated from the sensor data, date information (TMDT) is added to the data of the daily contacting number (TMNM) and contacting time (TMTI), and the performance rated value (TMPQ) of this user (US) to constitute a set of data, and this set of data has been collected for a plurality of days. The performance rated value (TMPQ) is set, for example, by choosing an item from the items shown in the self-rating questionnaire (ASPS) of FIG. 30, or by setting a new variable by processing the plurality of items, or using the data acquired from other than the self-rating questionnaire (ASPS).

Moreover, for the contacting number (TMNM) and the contacting time (TMTI) on the performance connected table (ASPC), the average values (REave) are calculated in advance, and then in plotting a symbol on the diagram, these average values are plotted as the representative values of this user (US) onto the relevant coordinate plane. A method other than the averaging may be used in order to determine the coordinate value.

Next, the size of a graph area is determined (IP220) and the maximal values of the contacting number and contacting time are calculated (IP230). These are the same processes as the process (IP10) and the process (IP20) in FIG. 13 of Embodiment 1, respectively. In the case where the reference lines for dividing the graph into four areas are added to the display, the calculation and plot of the reference values are performed in advance, as in the processes (IP81, IP82, IP83) of FIG. 19 of Embodiment 2.

Next, one member is chosen (IP240), and the contacting time data (TMTI), contacting number data (TMNM), and performance rated value (TMPQ) in the performance connected table (ASPC) are normalized, respectively (IP250), and then the data on the performance connected table (ASPC) is replaced with the data after the normalization. Then, a multiple regression equation is formulated for each line of the performance connected table (ASPC), (IP260), to get partial regression coefficients corresponding to the contacting number and time (IP270). The direction of an arrow to be plotted is determined in accordance with the positive or negative of the respective partial regression coefficients.

Next, the average values of the contacting number and the contacting time of this member are plotted. However, since the flow from the step of calculating coordinate values of the vertical axis and horizontal axis (IP290) to the step of plotting symbols (IP300, IP301) are the same as the process (IP40) to the processes (IP71, IP75) in FIG. 13 of Embodiment 1, the description thereof is omitted.

Finally, an arrow of the direction previously determined is plotted on the plotted symbol (IP310).

These steps are repeated until the plot for all the members is finished (IP320), and then the flow will end (IPEN).

### <Self-Rating Questionnaire>

FIG. 30 is an example of the self-rating questionnaire (ASPS) used in the fourth embodiment of the present invention.

The self-rating questionnaire (ASPS) is used for each member to put the subjective rating regarding the result of the work, the process of the work, and the physical conditions, thereby analyzing the connection between the subjective rating and the feature quantities (here, the contacting number and the contacting time) obtained by the sensor.

The rating items are the degree of execution of the work, the degree of satisfaction in the work as a whole, the individual's task in the process of the work, the face-to-face communication or the communication in cyber space, the mental health, the physical health, and free description.

Moreover, along with the rating on the individual, with respect to some of the rating items the result of the work as a project is also rated in parallel. Normally, with respect to all the projects, all the members belonging thereto should perform self-rating, however, a member involved in a plurality of projects will have too much load. For this reason, for each member, a project to be rated is designated as a main project, whereby the rating on his/her work regarding the main project, rating on the work including other members, and furthermore the rating on all the projects involved are separated.

The above rating items are scaled from 1 to 5 except the free description in the field of others (RS300).

In this embodiment, the user (US) looks back on each one's work once a day, for example, to fill in a rating on each item of this sheet. In FIG. 30, it is assumed that a person in charge puts a mark on a printed-out sheet by hand and then collectively inputs this to the client (CL) or the application server (AS), however, an input window may be prepared so that each user (US) may input the rating directly to the client (CL) or the application server (AS).

The daily inputted rating data by all the users (US) is stored in the recording unit (ASME) in the application server (AS) as the self-rating table (ASPT), i.e., a set of date, user name (ASUIT2) or user ID (ASUIT3), rating item number, and rating data.

### <Description of Each Item>

In FIG. 30, assume that a printed-out blank self-rating questionnaire is distributed to each user (US) so that the user (US) may fill in this by hand.

First, the date (RS01) and name (RS02) are filled in. The date (RS01) refers to the day and month to be rated, and the name (RS02) refers to the user name (ASUIT2). These may be filled in by the user (US) himself/herself or a pre-filled questionnaire may be distributed.

For a main project (RS03), among the projects which the relevant user (US) belongs to, the one which the user especially desires to be rated is chosen and filled in. The user (US) himself/herself may choose this main project (RS03) from the projects which are the core of the current work, or an analyst may designate this.

A question item (RS10) indicates the content of an item to be rated.

The question item (RS10) is categorized roughly into the evaluation of result (RS100), the evaluation of process (RS200), and others (RS300).

The evaluation of result (RS100) and the evaluation of process (RS200) are separated from each other because in daily work, the evaluation of result (good or bad) of the work may occur as the comprehensive results with respect to the processes, such the individual's task, conversation with others, or his/her own physical condition and mental condition. Note that a self-rating questionnaire that does not separate these may be used. Moreover, the field of others (RS300) is provided for taking a note of the events, and thoughts, and the like on the target day and month by free writing.

The evaluation of result (RS100) includes the items of the degree of execution of his/her own work as a whole, the degree of execution of his/her most important issue, and the satisfaction rating. The satisfaction rating is his/her own subjective rating with respect to the results of the work including not only whether achieved or not but also all other aspects.

The evaluation of process (RS200) includes the items of the individual's task, communication, mental health, and physical health. Furthermore, in the item of communication, the face-to-face communication and the communication in cyber space (mail or blog, or the communication via a social network) are separated from each other. This is based on an idea that in an organization, the effect caused by face-to-face communication and the effect caused by communication in cyber space differ in quality. The item of individual's task is used for evaluation concerning the work, such as information collection, analysis, and documentation, which basically a person tackles with alone. The item of mental health is used for evaluation concerning the mental vigorousness, and the item of physical health is used for evaluation concerning the physical condition.

Note that, for the performance rating concerning an individual and the performance rating concerning a project, rating items other than those in FIG. 30 may be used. Moreover, the result of Embodiment 4 (FIG. 26) is the one obtained using the evaluation result of “related project as a whole” in the item of “satisfaction rating”, at the time of performing the multiple regression analysis on the sensor data and the performance self-rating.

### Embodiment 5

A fifth embodiment of the present invention is described with reference to the accompanying drawings.

### Overview of Embodiment 5

Embodiment 5 allows a distribution of communication styles of members in an organization to be analyzed along in chronological order based on the expression of Embodiment 1.

### <Finished Image>

FIG. 32 shows an example of the result of a display created in the fifth embodiment of the present invention. The horizontal axis represents date and the vertical axis represents the principal component axis for the contacting number and the contacting time. Furthermore, the principal component axis is equally divided, and the color of this segmented interval or the depth of a color is varied depending on the number of members taking a form of communication belonging to the segmented interval. In FIG. 32, the number of persons is expressed with the depth of a color. The color is white if the number of persons is 0. For example, as on February 21, in the case where the color is light but is broadly appearing from the bottom to the top, it is found that a person having a lot of communication through a person having few communication are evenly distributed across the organization. Moreover, as on March 28, in the case where the dark colored ones are concentrated on the upper part, it is found that the communication was active across the organization.

Furthermore, as a whole, before or after March 13 in the center of the graph, it appears that there were few communication and it was a quiet atmosphere, while on March 19 and thereafter the communication abruptly increased to be activated. In Embodiment 5, a large wave motion of the whole organization can be captured in this manner.

In this case, the above-described correlated display is a display by converting a two-dimensional distribution, the two-dimensional distribution being obtained in plotting a symbol corresponding to a person on a coordinate plane consisting of two axes, in which a feature quantity indicative of an intensity is assigned to one axis and a feature quantity indicative of a diversity is assigned to other axis, into a one-dimensional distribution on a principal component axis that is set on the coordinate plane based on a predetermined criteria. The visualization system for organizational communication further performs the correlated display, which was performed at a predetermined time, in a similar manner at other time point, and one-dimensionally arranges the one-dimensional distribution at each time point along a time sequence including the each time point, and displays the resultant arrangement as a distribution on a coordinate plane consisting of two axes, in which the principal component axis is assigned to one axis and the time sequence is assigned to other axis, thereby displaying a transition of the one dimensional distribution between the respective time points.

Note that, instead of expressing the number of persons with a color or the depth of a color, one color may correspond to one member so that what kind of communication this member performed can be tracked.

### <Enlarged View>

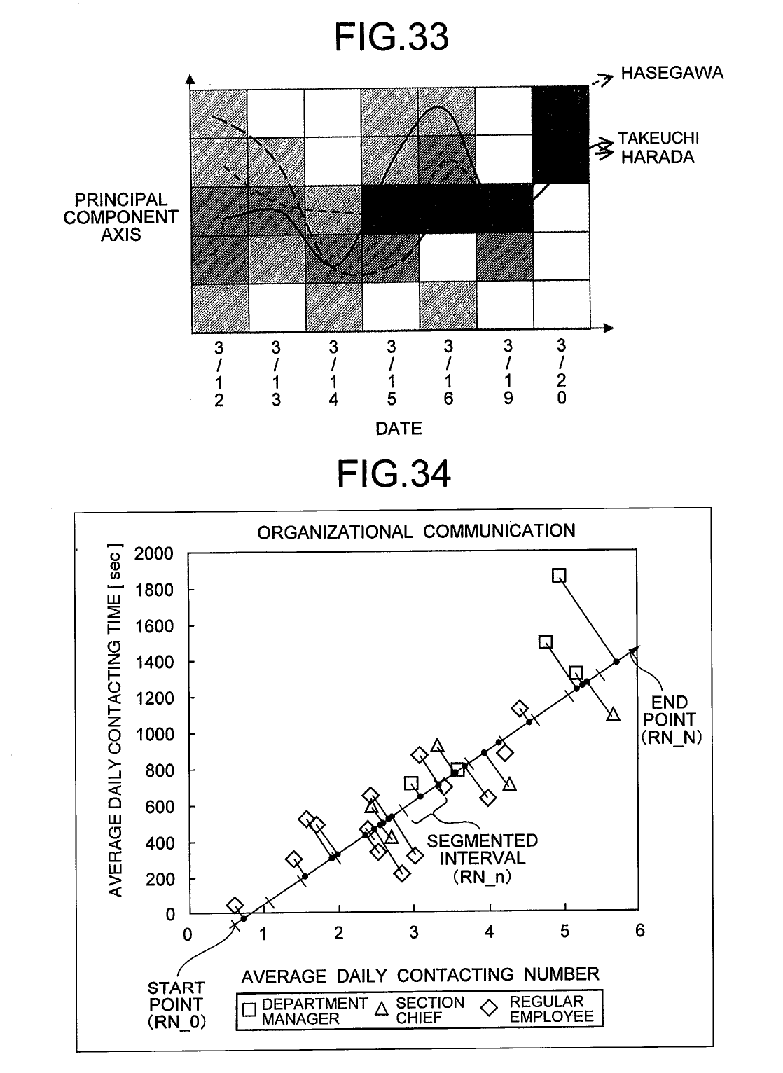

FIG. 33 is an example of a screen when the screen of FIG. 32 is enlarged and re-displayed. In enlarging the screen, which member belongs to which segmented area and also a line indicative of a move path across the segmented frames are displayed. The line may be displayed paying attention only to some of the members or may be displayed for all the members. Moreover, in FIG. 33, the members are displayed with the different types of lines for the respective members.

<Projection onto Principal Component Axis>

FIG. 34 is an explanatory view in the case where the principal component axis is created from the drawing of Embodiment 1 and then the data is projected onto this axis, in Embodiment 5 of the present invention.

On the graph, in which the data for one day is plotted on two axes of the contacting time and the contacting number using the method of Embodiment 1, the principal component axis is drawn and then the perpendicular to the principal component axis is drawn from all the plotted data. An intersection between the perpendicular and the principal component axis is defined as a new value indicative of the communication. In this case, the references of a start point (RN_0) and an end point (RN_N) are determined in advance in such a manner that the end of the principal component axis is defined as 0 and the tip on the graph is defined as 100. This principal component axis is the vertical axis of Embodiment 5 (FIG. 32).

In this case, the above-described correlated display is a display by converting a two-dimensional distribution obtained when a symbol corresponding to the person is plotted on the coordinate plane consisting of two axes, in which a feature quantity indicative of an intensity is assigned to one axis and a feature quantity indicative of a diversity is assigned to other axis, into a one-dimensional distribution on the principal component axis that is set on the coordinate plane based on a predetermined criteria.

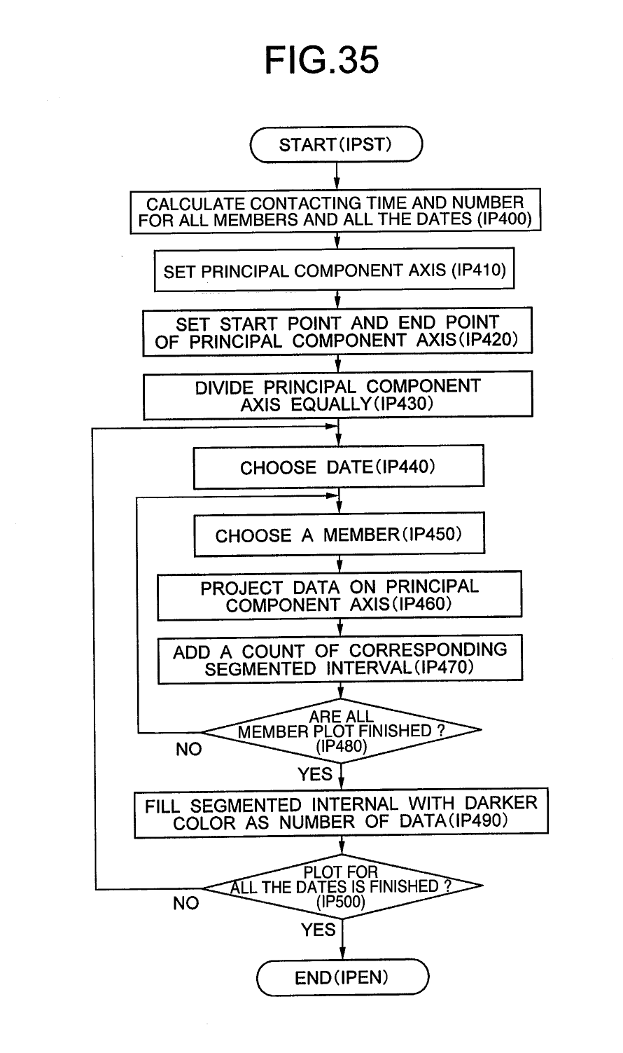

Note that, while the principal component axis is determined as a result of conducting a principal component analysis on the plotted data, the regression line calculated using the least square method or the like may be used. Moreover, in order to express a chronological change in a long period of time, the axis is preferably fixed on whichever date. For this reason, after calculating the coordinate values in Embodiment 1 with respect to all the dates and all the members in a period used for a display, the principal component axis may be calculated and fixed for use in the calculation of projection for each day. In a flowchart of FIG. 35, the description is made using a method of determining the principal component axis, first, and then performing the calculation of each day.

### <Flowchart>

FIG. 35 is a flowchart showing the details of the step of plotting data (APIP) in the overall flowchart of FIG. 3, in the fifth embodiment of the present invention.

After starting to plot data (APIP), (IPST), the contacting time and contacting number for all the members and all the dates used in display are calculated first (IP400). Furthermore, with the use of the above-described method, the principal component axis is set (IP410), and the start point (RN_0) and the end point (RN_N) of the principal component axis are set (IP420). The range between the start point (RN_0) and the end points (RN_N) is equally divided to set each segmented interval (IP430). The number of segments is set to an appropriate value in advance.

Next, one date is chosen (IP440), and furthermore one member is chosen (IP450). The values of the contacting time and the contacting number of this day of this member are projected onto the principal component axis (IP460). Furthermore, in what position in the sequence of the segmented intervals the projected value is included is calculated and then a count is added to the corresponding segmented interval (IP470). In this way, after finishing the counting of all the members (IP480), an area having a lot of counted number of persons is filled with a darker color at the corresponding date on the graph as shown in FIG. 32 (IP490). If the plot for all the dates is finished (IP500), the flow will end (IPEN).

### Embodiment 6

A sixth embodiment of the present invention is described with reference to the accompanying drawings.

### Overview of Embodiment 6

In Embodiment 6, a communication style is expressed with one color by causing two variables of the contacting number and contacting time, which are calculated using the same process as that of Embodiment 1, to correspond to hue and brightness, respectively. Since this allows the communication style of one person within a predetermined unit of time to be expressed with one segmented area, it is possible to express all these communication styles on a two-dimensional plane, with a chronological change taken on the horizontal axis and all the members belonging to an organization taken on the vertical axis. Note that, for the axes, the members belonging to an organization may be taken on the horizontal axis and the chronological change may be taken on the vertical axis. Moreover, other elements may be used as the axes.

In this case, the above-described correlated display is a display that is performed by generating a single color tone, in which a feature quantity indicative of an intensity is assigned to either one of the hue and brightness and a feature quantity indicative of a diversity is assigned to the other one of the hue and the brightness. If the correlated-display performed to one person is further performed to other person in the organizational in a similar manner, and the communication style of each person within a predetermined unit of time is shown corresponding to each one segmented area, and further the segmented area is one-dimensionally arranged, then a difference in the communication styles between the respective persons can be displayed as a change in the color tone. Alternatively, if the correlated-display performed to one person at a predetermined time point is further performed to this person in a similar manner at other time point, and the communication style within a predetermined unit of time is shown corresponding to each one segmented area for each time point, and further the segmented area is one-dimensionally arranged, then a transition in the communication style between the respective time points can be displayed as a change in the color tone. Furthermore, if the correlated-display performed to the one person at each time point is further performed to other person in the organizational in a similar manner at each time point, and a coordinate plane consisting of two axes, in which a transition in the communication styles of each person on a time sequence including the each time point is assigned to one axis and a difference in the communication style between the respective persons is assigned to other axis, is created, then a chronological change in the communication style of the organization and a difference between persons can be displayed collectively on the coordinate plane.

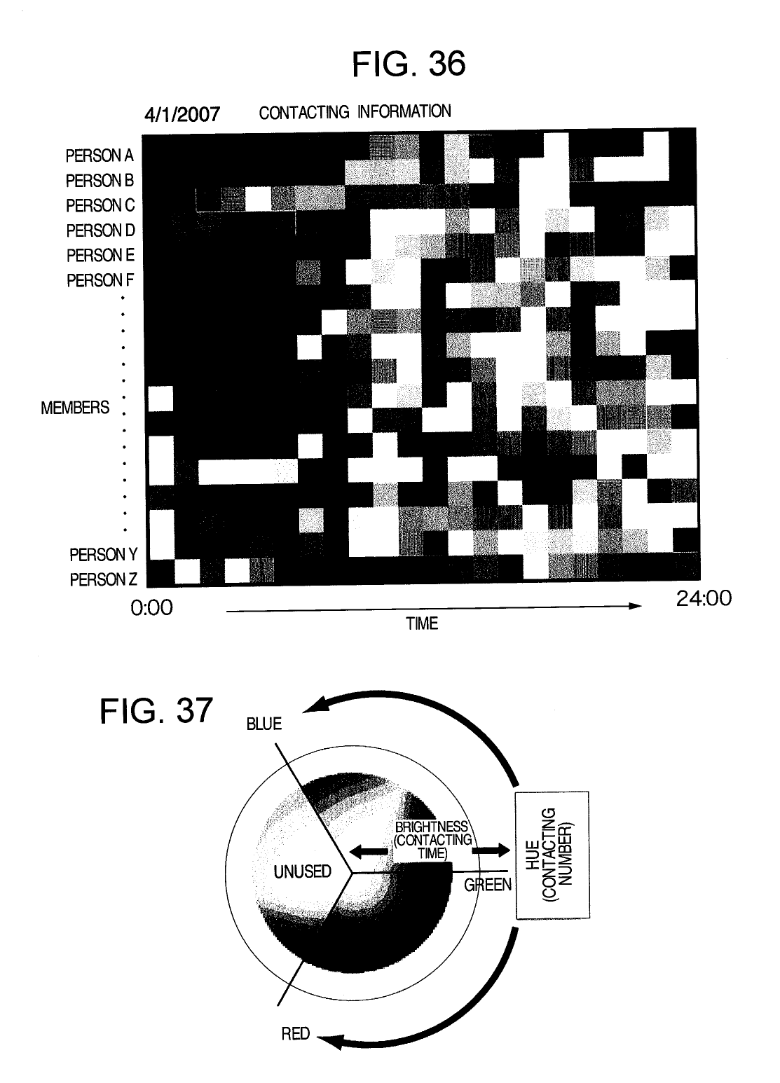

FIG. 36 shows an example of the result of a display created in the sixth embodiment of the present invention. The horizontal axis represents time and the vertical axis represents the members belongs to an organization, and a horizontal one line expresses a chronological change in the communication style concerning one member. Note that the unit of time of one segmented area can be set arbitrarily. For example, the unit of time may be set to one hour to arrange 24 areas, so that one day may be expressed with one end of the horizontal axis to the other end. Moreover, the unit of time may be set to one day to arrange 365 areas, so that one year portion may be expressed with one end of the horizontal axis to the other end.

Accordingly, it is possible to view this graph as one piece of drawing when looking down from a distant viewpoint, so that a tendency on the relevant day and a wave motion in the temporal vitality across an organization can be captured with one's eyes. Moreover, if taking a close look at one part, who was actively communicating on the relevant day, which time zone a meeting was held, and the like can be captured.

FIG. 37 shows a hue circle used to associate the contacting number and the contacting time with colors. For example, the hue is assigned to the contacting number and the brightness is assigned to a total time to thereby express a distribution across persons or a chronological change in the communication style. Here, since the hue periodically varies, as a distribution of colors to be used, for example, red is set to the maximal value and blue is set to the minimal value so as not to use all the orientations of the hue circle (i.e., an unused portion exists). This is because if all of the 360 degrees are used the colors indicative of the minimal value and the maximal value become the same color and cannot be distinguished from each other.

As described above, according to the respective embodiments of the present invention, for example, in a consulting industry for supporting productivity improvement through personnel management, project management, and the like, the communication style of members belonging to an organization, the communication style of an organization, and the communication style of a sub-organization can be visualized from actual face-to-face communication data.

It should be further understood by those skilled in the art that although the foregoing description has been made on embodiments of the invention, the invention is not limited thereto and various changes and modifications may be made without departing from the spirit of the invention and the scope of the appended claims.

1. A computer system for organizational communication, comprising:
a plurality of terminals,
an input device configured to receive performance data, and
a processing unit configured to process data sent from the plurality of terminals,
wherein each of the terminals comprises:
a sensor configured to detect sensor data from another terminal; and
a sensor data sender unit configured to send the sensor data detected by the sensor;
wherein the input device comprises an input unit configured to receive the performance data; and
wherein the processing unit is further configured to process sensor data sent
from a first terminal and performance data that is provided by a person equipped with the first terminal.

2. The computer system for organizational communication according to claim 1,
wherein the sensor data and the performance data include time information; and
wherein the processing unit is further configured to process the sensor data and the performance data in relation to the time information.

3. The computer system for organizational communication according to claim 1,
wherein the sensor data and the performance data include a user ID information; and
wherein the processing unit is further configured to process the sensor data and the performance data in relation to the user ID information.

4. The computer system for organizational communication according to claim 2,
wherein the sensor data and the performance data include user ID information; and
wherein the processing unit is further configured to process the sensor data and the performance data in relation to both the user ID information and the time information.

5. The computer system for organizational communication according to claim 1, further comprising,
a display device configured to display a person, the sensor data which is sent from a terminal which is equipped by the person, and the performance data that is input by the person.

6. The computer system for organizational communication according to claim 1, further comprising a display device;
wherein the performance data is a numerical number;
wherein the processing unit is further configured to calculate a correlation relation between the sensor data and the performance data; and
wherein the display device is configured to display the correlation relation.

7. The computer system for organizational communication according to claim 6,
wherein the sensor data and the performance data include time information; and
wherein the processing unit is further configured to calculate a correlation relation between the sensor data and the performance data in relation to the time information.

8. The computer system for organizational communication according to claim 6,
wherein the sensor data and the performance data include user ID information; and
wherein the processing unit is configured to calculate a correlation relation between the sensor data and the performance data in relation to the user ID information.

9. The computer system for organizational communication according to claim 7,
wherein the sensor data and the performance data include user ID information; and
wherein the processing unit is configured to calculate a correlation relation between the sensor data and the performance data in relation to the user ID information and the time information.

10. The computer system for organizational communication according to claim 6, further comprising a display device;
wherein the sensor data includes face-to-face contact time data and a number of face-to-face contacts with a person;
wherein the processing unit is further configured to calculate a time-correlation relation between the face-to-face contact time data and the performance data, and a number-correlation relation between the number of face-to-face contacts and the performance data; and
wherein the display device is configured to display the time-correlation relation and the number-correlation relation.

11. The computer system for organizational communication according to claim 10,
wherein the time-correlation relation includes a time-correlation coefficient between the face-to-face contact time data and the performance data, and the number-correlation relation includes a number-correlation coefficient between the number of face-to-face contacts and the performance data; and
wherein the display device is configured to display the time-correlation coefficient and the number-correlation coefficient by vector representation.

12. A computer system for organizational communication, comprising:
a plurality of terminals comprising a sensor configured to detect sensor data from another terminal, and a data sender unit configured to send the sensor data detected by the sensor;
a client configured to send performance data and a request to process data, receive a processed result, and display the received result on a screen; and
an application server configured to process data sent from the plurality of terminals and the client;
wherein the application server is further configured to perform a correlated processing for sensor data sent from a first terminal and performance data that is provided by a first client.

13. The computer system for organizational communication according to claim 12,
wherein the application server is further configured to send a result of the correlated processing to the client; and
wherein the client is further configured to display the result of the correlated processing.
